(19) United States
(12) Patent Application Publication
(10) Pub. No.: US 2025/0391176 A1
(43) Pub. Date: Dec. 25, 2025

(54) TARGET AVATAR IDENTIFICATION APPARATUS, AND CONTROL METHOD FOR APPARATUS

(71) Applicant: LG ELECTRONICS INC., Seoul (KR)

(72) Inventors: Sunghwan CHOI, Seoul (KR); Taekyoung KIM, Seoul (KR); Heemin LEE, Seoul (KR); Jungryul SEO, Seoul (KR); Kihyung LEE, Seoul (KR)

(73) Assignee: LG ELECTRONICS INC., Seoul (KR)

(21) Appl. No.: 18/879,538

(22) PCT Filed: Mar. 24, 2023
(86) PCT No.: PCT/KR2023/003976

§ 371 Date: Dec. 27, 2024

(30) Foreign Application Priority Data
Jun. 29, 2022 (KR) 10-2022-0079894

(51) Int. Cl. G06V 20/58; G06T 7/70; G06V 40/10; H04N 7/18

(52) U.S. Cl. CPC G06V 20/58; G06T 7/70; H04N 7/183; G06T 2207/30252; G06V 40/10

(57) ABSTRACT

The present invention comprises: an interface unit for receiving an image of the vicinity of a vehicle; anchor sensors which attempts, according to a preset communication scheme, wireless communication with a target device corresponding to pre-stored identification information, and which exchanges messages for calculating the position of the target device; and a processor for calculating the position of the target device on the basis of the wireless communication connection state between the anchor sensors and the target device, receiving, through the interface unit, an image sensed by a camera oriented in the direction of the target device, calculating the positions of respective avatars included in the received image, and identifying, as that which corresponds to the target device, an avatar positioned within a preset error distance from the calculated position of the target device from among the positions of the respective avatars, calculated through the image.

### TECHNICAL FIELD

The present disclosure relates to an apparatus provided in a vehicle and, more particularly to, an apparatus for identifying a target object, such as a passenger authorized to ride, in the vicinity of a vehicle.

### BACKGROUND ART

With recent significant developments in autonomous driving technology for vehicles, unmanned autonomous driving (the 5^{th} autonomous driving), in which vehicles operate independently without drivers or passengers, has become feasible, surpassing autonomous driving (the 3^{rd} and 4^{th} autonomous driving) in which drivers must remain attentive to the road or take direct control of the vehicle on certain road sections or under preset conditions. Thanks to these developments in autonomous driving technology, services such as unmanned taxis or car sharing have appeared in recent years.

In the case of the services such as unmanned taxis or car sharing, when a caller or a person who made a reservation calls a vehicle, an autonomous driving vehicle drives autonomously to a designated place and picks up the caller or the person at the designated place. In this manner, the services are provided. Moreover, since the autonomous driving vehicle operates autonomously without a driver or a passenger, the services may be provided in a completely automated manner without any user involvement.

Therefore, the autonomous driving vehicle used in this service is required to pick up a designated caller or a person who made a reservation. Thus, the service has to be provided only to the caller or the person who made a reservation. Consequently, in this situation, technology for accurately identifying the caller or the person who made a reservation, that is, a designated target is very important.

In addition, in recent years, significant developments in virtual reality technology that uses augmented reality and digital twin, have enabled vehicles to efficiently provide more diverse and detailed information about their surrounding environments, that is, their various nearby objects, to occupants of their vehicles.

Moreover, these developments in virtual reality technology have enabled a metaverse that is a 3-dimensional virtual space shared by a multiplicity of users. Accordingly, using metaverse technology, current vehicles provide a social function of communication with another user with which the 3-dimensional virtual space, that is, the metaverse is shared by displaying a virtual space corresponding to their surrounding environments, displaying avatars corresponding to the other user in the virtual space, and through interactions between the avatars.

In the case of the metaverse technology associated with vehicles, among pedestrians or vehicles in the vicinity of a vehicle, another user associated with an occupant of the vehicle can be displayed by displaying the vehicle and the space in the vicinity of the vehicle as a 3-dimensional virtual space and displaying various avatars corresponding to other different users within the displayed virtual space. For this metaverse technology, among objects (for example, pedestrians or vehicles) in the vicinity of the vehicle, an object linked to another user associated with the occupant of the vehicle can be accurately identified. Accordingly, the importance of technology for accurately identifying various objects in the vicinity of the vehicle has become increasingly evident.

This widely used method of identifying an object in the vicinity of the vehicle involves a vision imaging technique of identifying an object included within an image captured by a camera, using the features of the object, is widely used. However, in order to accurately identify an object using this vision imaging, feature information of the object is required to be pre-stored. Moreover, in a case where the object intended to be identified is a person, the feature information of the person is required.

Therefore, with the vision imaging technique, identifying a person who is not a celebrity or a public figure widely recognized for public interest is impractical due to a lack of available feature information. In addition, for a person's face, privacy concerns related to the image rights may occur. As a result, there is a problem in that individuals are difficult to identify with the vision imaging technique.

### DISCLOSURE OF INVENTION

### Technical Problem

In order to address the aforementioned and other problems, one object of the present disclosure is to provide a vehicular object identification apparatus capable of more accurately identifying an object in the vicinity of a vehicle, particularly an individual, associated with a specific service, such as a vehicle caller or a person who made a reservation, and a method of controlling the vehicular object identification apparatus.

In order to address the problem of the difficulty in accurately identifying an object, particularly an individual, in the vicinity of a vehicle using a vision imaging technique in the related art, another object of the present disclosure is to provide a vehicular object identification apparatus capable of more accurately and quickly identifying an object in the vicinity of a vehicle using not only an image captured by a camera, but also short-range communication, and a method of controlling the vehicular object identification apparatus.

Still another object of the present disclosure is to provide a vehicular object identification apparatus capable of providing a social function of interaction in a metaverse virtual space for a user and other persons associated with the user by applying the result of recognizing an object in the vicinity of a vehicle to a virtual space in accordance with metaverse technology through a communication connection to a cloud server, and a method of controlling the vehicular object identification apparatus.

### Solution to Problem

In order to achieve the aforementioned and other objects, in one aspect of the present disclosure, there is provided an object identification apparatus according to an embodiment of the present disclosure, the object identification apparatus including: an interface unit that receives an image of a vehicle's surroundings, acquired by at least one camera provided in the vehicle; at least one anchor sensor that attempts to wireless communication with a target device, corresponding to pre-stored identification information, in compliance with a preset communication scheme and, when a wireless communication connection to the target device is established, exchanges at least one message for computing the location of the target device; and a processor that computes the location of the target device based on a state of the wireless communication connection of the at least one anchor sensor to the target device, receives an image, captured by the camera facing the direction of the target device, through the interface unit, computes the locations of objects included in the received image, and identifies any one object located within a preset error distance from the computed location of the target device, among the locations of the objects, which are computed through the image, as a target corresponding to the target device.

In an embodiment, the object identification apparatus may further include a communication unit that performs wireless communication with a cloud server which provides a metaverse platform and provides a service associated with a metaverse virtual space to the vehicle through the metaverse platform, wherein the processor may transmit the location information of any one target identified as corresponding to the target device, among objects in the vicinity of the vehicle, to the cloud server, and, in response to the transmission of the location information of the identified target, may receive information about the metaverse virtual space in which an avatar corresponding to the identified target is displayed in the vicinity of the vehicle, from the cloud server.

In an embodiment, in the object identification apparatus, the location information of the identified target may be any one of the following: a first location corresponding to the direction of the target device, which is computed both from the distance to the target device, the distance being computed using the transmission time and reception time of a message exchanged between the at least one anchor sensor and the target device and from an arrival of angle (AOA) of a signal received from the target device, or a second location corresponding to a direction which is computed both from a distance that is computed using the depth information of an object corresponding to the identified target included in the image captured by the camera facing the direction of the target device and from a gap from the view angle center of the captured image to the center of the object corresponding to the identified target.

In an embodiment, in the object identification apparatus, the cloud server, when receiving the location information of the identified target, may further detect another user with whom the metaverse virtual space is preset to be shared in the vicinity of the location of the vehicle, and, as a result of the detection, may further transmit an avatar of and the location information of at least one other user with whom the metaverse virtual space is shared, to the processor, and the processor may control the interface unit in such a manner that an image of the metaverse virtual space in which an avatar of the identified target and the avatar of the at least one other user are displayed in the vicinity of an object corresponding to the vehicle, is displayed on a display unit of the vehicle.

In an embodiment, in the object identification apparatus, the processor may control the interface unit in such a manner that the received image of the metaverse virtual space is displayed on a display unit of the vehicle, and the image of the metaverse virtual space may be an image in which the object identified as corresponding to the target device, among the objects in the vicinity of the vehicle, is displayed as the avatar in a manner that is distinguished from the other remaining objects that are not identified.

In an embodiment, in the object identification apparatus, in a case where a location in the image, which corresponds to the target device, is a wall or an obstacle, as a result of detecting the location of the target device in accordance with the state of the wireless communication connection to the target device, from the image captured by the camera facing the direction of the target device, the processor may detect that the target corresponding to the target device is hidden behind the wall or the obstacle, and may control the interface unit in such a manner that an image of the metaverse virtual space, in which the wall or the obstacle in the image, each of which corresponds to the location of the target device, or the avatar is displayed translucently and thus the location of the target corresponding to the target device hidden behind the wall or the obstacle is displayed, is displayed on a display unit of the vehicle.

In an embodiment, in the object identification apparatus, the identification information of the target device may be information about target equipment carried by a subscriber of a specific service provided by the cloud server.

In an embodiment, in the object identification apparatus, the target equipment may be communication equipment supporting wireless communication in compliance with the preset communication scheme or equipment to which a tag including a radio frequency (RF) circuit capable of performing the wireless communication in compliance with the preset communication scheme is attached.

In an embodiment, in the object identification apparatus, the preset communication scheme may be a communication scheme that uses a wireless signal in an ultrawide band (UWB).

In an embodiment, in the object identification apparatus, the processor may set one point in the vehicle as a reference point, and may calibrate the location of the target device, which is computed with the at least one anchor sensor with a reference, as a location with the reference point as a reference, through coordinate conversion from a coordinate system with the location of each anchor sensor as a reference to a coordinate system with the set reference point as a reference.

In an embodiment, in the object identification apparatus, the number of the anchor sensors may be 2 or greater, and, through the coordinate conversion, the processor may calibrate the locations of the target device, which are computed with each of the two or more anchor sensors as a reference, as locations in accordance with the coordinate systems with the reference point as a reference, and may compute the coordinate average of the locations resulting from the calibration, thereby determining the location of the target device.

In an embodiment, in the object identification apparatus, the processor may set one point in the vehicle as a reference point, and may calibrate the location of the target device, which is computed with the location of the camera as a reference, to a location with the reference point as a reference, through coordinate conversion from a coordinate system with the location of each anchor sensor as a reference to a coordinate system with the set reference point as a reference.

In an embodiment, in the object identification apparatus, the reference point may be a point at which the center axis, connecting the front surface center of the vehicle and the rear surface center of the vehicle, intersects with the rear vehicular axis, connecting the centers of the rear wheels of the vehicle.

In an embodiment, in the object identification apparatus, the processor may detect any one camera that captures an image corresponding to a field of view (FOV) including the direction of the target device, the direction being computed based on the state of the wireless communication connection to the target device, from among the plurality of cameras provided in the vehicle, and may compute the locations of the objects included in the image captured by the detected camera.

In an embodiment, the object identification apparatus may further include a location computation unit that computes the GPS location of the vehicle and the GPS location of the target device, wherein, in a case where as a result of computing the locations, the distance between the GPS location of the vehicle and the GPS location of the target device exceeds a preset distance, the processor may keep the at least one anchor sensor in a deactivated state, and wherein, in a case where the distance between the GPS location of the vehicle and the GPS location of the target device is equal to or shorter than the preset distance, the processor may switch the at least one anchor sensor from the deactivated state to an activated state, thereby establishing the wireless communication connection between the at least one anchor sensor and the target device.

In an embodiment, in the object identification apparatus, in a case where a plurality of objects are located within the preset error distance from the computed target device, the processor may identify at least one of the plurality of objects as a target group corresponding to the target device, based on the locations of the objects, the locations being computed from the image, and may transmit the location information of each of the objects included in the target group to the cloud server.

In an embodiment, in the object identification apparatus, in response to the location information of each of the objects included in the target group, the cloud server may display an avatar, corresponding to the identified target, on any one object whose location computed from the captured image is most adjacent to the location of the target device in accordance with the state of the wireless communication connection to the target device, among the objects included in the target group, and, in response to the transmission of the location information of the objects included in the target group, may provide an image of the metaverse virtual space in which the other remaining objects in the target group are displayed.

In order to achieve the aforementioned and other objects, in another aspect of the present disclosure, there is provided a method of controlling an object identification apparatus, the method including: a step of receiving the identification information of a specific target device: a step of attempting to perform wireless communication with the target device in compliance with the preset communication scheme using at least one anchor sensor and performing pairing with the target device when a wireless communication connection to the target device is established; a step of exchanging, by the at least one anchor sensor, a message for computing the location of the target device and computing the location of the target device by exchanging the message, when the pairing is established; a step of detecting a camera that captures an image in a direction in accordance with the location of the target device, from a vehicle; a step of computing the locations of objects within the image captured by the detected camera, the locations including the distances and directions of the objects from the camera, based on depth information and the view angle center; a step of detecting the location of an object located within a preset error distance from the target device, from among the computed locations of the objects; and a step of identifying an object in the image, the object being located within the error distance from the target device, as a target corresponding to the target device.

In an embodiment, the method may further include: a step of transmitting the location information of an identified target corresponding to the target device to a cloud server that provides a metaverse platform and provides a service associated with a metaverse virtual space through the metaverse platform; a step of receiving information about the metaverse virtual space including an avatar corresponding to the identified target, in response to the transmission of the location information; and a step of displaying, according to the received information about the metaverse virtual space, an image of the metaverse virtual space in which the avatar is displayed at the location of the identified target, on a display unit of the vehicle.

### Advantageous Effects of Invention

The effects of a vehicular object identification apparatus and a method of controlling the vehicular object identification apparatus according to the present disclosure are described as follows.

According to at least one of the embodiments of the present disclosure, a wireless communication connection to a predesignated target device is established using the identification information of the predesignated target device. Then, a target object who carries the designated target device detected in accordance with the established wireless communication connection and an object detected from an image captured by a camera provided in a vehicle are used. Thus, according to the present disclosure, the target object can be identified from among objects included in the captured image. Accordingly, the effect of accurately and quickly identifying the target object from the surroundings of the vehicle without information about the features of the target object can be achieved.

In addition, the wireless communication connection of the vehicle to the target device is temporarily established according to the distance between the vehicle and the target device. Thus, the present disclosure can achieve the effect of being able to accurately and quickly identify the target object from the surroundings of the vehicle while conserving the power of both the vehicle's battery and target device's battery.

In addition, the location information of the target object identified from the surroundings of the vehicle is provided to a cloud server providing a 3D virtual space in accordance with metaverse technology. Thus, according to the present disclosure, the cloud server is enabled to collect the accurate location of the target object. An avatar provided by the cloud server is displayed at a location in the 3D virtual space, which corresponds to the accurate location of the target object. Thus, the avatar can be displayed at the more accurate location of the target object in the metaverse virtual space. Therefore, the effect of more intuitively identifying another user associated with a user within the metaverse virtual space can be achieved, enabling more effective interactions and enhancing the overall enjoyment within the metaverse virtual space.

### BRIEF DESCRIPTION OF DRAWINGS

FIG. 1 is a block diagram illustrating the configuration of an object identification apparatus according to an embodiment of the present disclosure.

FIG. 2 is a flowchart illustrating the operational process in which the object identification apparatus according to the embodiment of the present disclosure identifies an object in the vicinity of a vehicle based on the result from capturing by a camera and the result of wireless communication through an anchor sensor.

FIG. 3 is a conceptual diagram illustrating the process of linking the object identification apparatus according to the embodiment of the present disclosure to a metaverse platform that is provided by a cloud server.

FIG. 4 is a conceptual diagram that is referenced to describe the process in which a signal recognition location of an object, which is based on the result of wireless communication through the anchor sensor, is measured in a vehicle equipped with the object identification apparatus according to the embodiment of the present disclosure.

FIG. 5 is a conceptual diagram that is referenced to describe the process in which a vision recognition location of an object from an image captured by the camera is measured in the vehicle equipped with the object identification apparatus according to the embodiment of the present disclosure.

FIG. 6 is a conceptual diagram that is referenced to describe the process in which a target is identified based on the signal recognition location measured using the anchor sensor and on the vision recognition location measured using the camera, in the vehicle equipped with the object identification apparatus according to the embodiment of the present disclosure.

FIG. 7 is a set of views illustrating examples where a target object identified in the vicinity of the vehicle is displayed in a distinguished manner on an augmented reality, virtual reality, or image map in the object identification apparatus according to the embodiment of the present disclosure.

FIG. 8 is a view illustrating an example where an error allowance range is applied in a manner that varies according to the number of objects detected at the vision recognition location, in the object identification apparatus according to the embodiment of the present disclosure.

FIG. 9 is a flowchart illustrating the operational process of activating the anchor sensor based on the distance between the vehicle and a target device in the object identification apparatus according to the embodiment of the present disclosure.

FIG. 10 is a flowchart illustrating the operational process in which, in a case where the target device is not detected, the location of the target object is detected by changing the output of the anchor sensor, in the object identification apparatus according to the embodiment of the present disclosure.

FIG. 11 is a view illustrating examples where, in a case where a target is hidden behind an obstacle or the like, the location of the detected target is displayed in the object identification apparatus according to the embodiment of the present disclosure.

FIG. 12 is a view illustrating examples of an image of a metaverse virtual space that includes a target vehicle on which an avatar of another identified user is displayed in the object identification apparatus according to the embodiment of the present disclosure.

FIG. 13 is a view illustrating an example where traffic information in the vicinity of the vehicle is provided to the metaverse platform and traffic information is displayed within the metaverse virtual space based on the provided traffic information, in the object identification apparatus according to the embodiment of the present disclosure.

FIG. 14 is a view illustrating an example where a specific vehicle is searched for using a method, according to an embodiment of the present disclosure, of identifying an object.

FIG. 15 is a flowchart illustrating the operational process in which the target device and the object identification apparatus limit the wireless communication of the anchor sensor to conserve battery power when distance renders wireless communication unnecessary.

FIG. 16 is a view illustrating an example where, according to the flowchart in FIG. 15 communication is performed between the anchor sensor and the target device based on the distance.

### MODE FOR THE INVENTION

It is noted that technical terms used in the present specification are only for describing specific embodiments and are not intended to impose any limitation on the scope of the present disclosure. In addition, the term used in the present specification, although expressed in the singular, is construed to have a plural meaning, unless otherwise meant in context. The terms “module” and “unit” used in the following description are coined and interchangeably used, considering only ease of description in the specification, and themselves are not intended to have different meanings or interpretations.

The expressions “configured to include,” or “include” should not be construed as necessarily including all various constituent elements or steps, which are described in the present specification. It should be understood that one or several of the constituent elements or the steps may not be included, or that one or several constituent elements or steps may further be included.

In addition, in a case where it is determined that a detailed description of the well-known technology in the relevant art to which the present disclosure pertains obscures the nature and gist of the technology disclosed in the present disclosure, the detailed description thereof is omitted from the present specification.

The accompanying drawings are only to help understand the embodiments disclosed in the present specification and do not impose any limitation on the technological idea disclosed in the present specification. All modifications, equivalents, and substitutions that fall within the scope of the technical idea of the present disclosure are reflected in the accompanying drawings. In addition, of course, not only the embodiments described below but also combinations of the embodiments, considered as modifications, equivalents, or substitutions may fall within the technical idea and scope of the present disclosure.

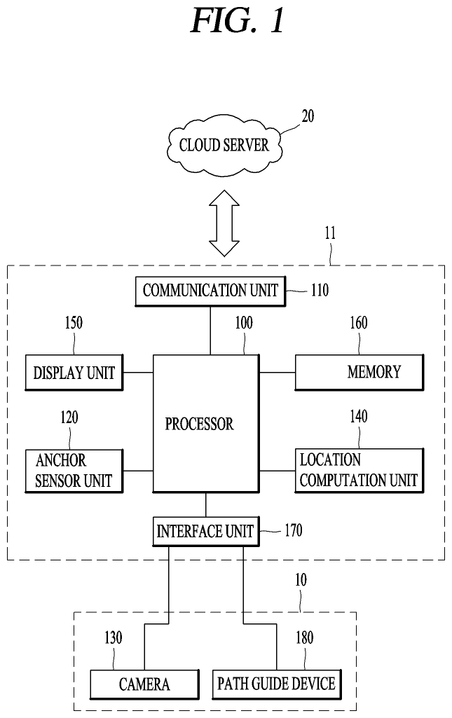

FIG. 1 is a block diagram illustrating the configuration of an object identification apparatus 11 according to an embodiment of the present disclosure.

With reference to FIG. 1, the object identification apparatus 11 according to the embodiment of the present disclosure may be described as being configured to include a processor 100, a communication unit 110 connected to the processor 100, an interface unit 170, a display unit 150, an anchor sensor unit 120, a location computation unit 140, and a memory 160. The constituent elements illustrated in FIG. 1 are not essential for implementing the object identification apparatus 11 The object identification apparatus 11 described in the present specification may include one or more additional constituent elements in addition to the constituent elements enumerated above or omit one or more constituent elements.

First, the anchor sensor unit 120 may include at least one anchor sensor. The anchor sensor here may be a sensor supporting wireless communication with a target device, in compliance with a preset scheme.

As an example, the anchor sensor may be a sensor supporting wireless communication in compliance with a preset scheme that uses radio waves with a broad band and low output. As an example, the anchor sensor may support wireless communication in compliance with an ultra-wideband (UWB) scheme. At this point, wireless communication in compliance with the UWB scheme may refer to a communication scheme that uses wireless signals in the UWB.

In this case, the target device may also be equipment supporting UWB wireless communication. For example, a variety of communication equipment, such as mobile terminals and smartphones, that can be carried by users, may be used as the target devices. Moreover, the target device may be equipment to which a radio frequency (RF) tag for supporting wireless communication in compliance with the UWB scheme is attached. Therefore, although equipment or an object does not support wireless communication, in a case where the RF tag is attached to the equipment or object, the equipment or object may be used as a target device.

When a UWB wireless communication connection is established between the anchor sensor and the target device, the anchor sensor unit 120 (or the processor 100) may measure the time for radio wave propagation between the target device and the anchor sensor. The distance and bearing between the anchor sensor and the target device may be measured with the anchor sensor as a reference. That is, the anchor sensor may be a sensor that serves as a reference, that is, an anchor, which measures the distance and bearing to the target device through wireless communication with the target device.

The anchor sensor unit 120 may include a plurality of anchor sensors. In this case, the anchor sensor unit 120 may measure the distance and bearing to the target device through each anchor sensor. Through the interface unit 170, the anchor sensor unit 120 may provide the distance and bearing to the target device, which are measured using each anchor sensor, to the object identification apparatus 11.

The anchor sensor unit 120 may be any one of the communication modules provided in a vehicle 10. In this case, the anchor sensor unit 120 may be connected to the processor 100 through the interface unit 170. Furthermore, by controlling the anchor sensor unit 120 through the interface unit 170, the processor 100 may establish a wireless communication connection to and pairing with the target device and receive information about the distance and bearing to the paired target device. However, for convenience in description, an example where the anchor sensor unit 120 is provided in the object identification apparatus 11 is described below.

The location computation unit 140 serves as a module for acquiring the location (or the current location) of the vehicle 10. Representative examples of this module may include a global positioning system (GPS) module and a wireless fidelity (WiFi) module. For example, the location computation unit 140, when utilizing the GPS module, may acquire the location of the object identification apparatus 11 (or the location of the vehicle 10 equipped with the object identification apparatus 11) using a signal transmitted by a GPS satellite.

As another example, the location computation unit 140, when utilizing the Wi-Fi module, may acquire the location of the object identification apparatus 11 (or the location of the vehicle 10 equipped with the object identification apparatus 11) based on information from a wireless access point (AP) that transmits or receives a wireless signal to and from the Wi-Fi module. The location computation unit 140 serves as a module used to acquire the location of the object identification apparatus 11 (or the location of the vehicle 10 equipped with the object identification apparatus 11) and is not limited to a module that directly computes or acquires a location.

The location computation unit 140 may be a module that is provided in the vehicle 10. In this case, the location computation unit 140 may be connected to the processor 100 through the interface unit 170. Furthermore, by controlling the location computation unit 140 through the interface unit 170, the processor 100 may receive either location information of the object identification apparatus 11 or the location information of the vehicle 10 equipped with the object identification apparatus 11. However, for convenience in description, an example where the location computation unit 140 is provided in the object identification apparatus 11 is described below.

The communication unit 110 may perform wireless communication between the object identification apparatus 11 and a preset server. To this end, the communication unit 110 may include at least one of the following: transmission and reception antennas, a radio frequency (RF) circuit, or an RF element, the radio RF circuit and the RF element being capable of implementing various communication protocols.

At this point, the communication unit 110 may be a communication unit provided in the vehicle 10 instead of the object identification apparatus 11. In this case, the object identification apparatus 11 may be connected to a communication unit of the vehicle 10 through the interface unit 170. Furthermore, through the interface unit 170, the processor 100 may also control the communication unit of the vehicle 10. However, for convenience in description, an example where the communication unit 110 is provided in the object identification apparatus 11 is described below.

The preset server serves as a cloud server 20 connected through wireless communication and may provide a metaverse platform providing a metaverse service.

In this case, the metaverse platform may include: an application programming interface (API) proxy server, which is connected, for communication, to the communication unit 110 of the object identification apparatus 11; a social network service (SNS) server, which provides a social network service; a digital twin server, which provides a Digital Twin as a Service (DTaaS) and a Mixed Reality Automotive Meta Service (MR AMS); and a rendering-streaming server, which provides 3D rendering and streaming services.

The SNS server here may include: a membership manager, which provides information about subscribers who register with a metaverse service; a session manager, which manages sessions, such as a talk group (for example, a wide talk room); a location information manager, which manages location information, such as the location, destination, and moving path, of each subscriber; a mobility life logging manager, which manages both driving events for each individual subscriber and logging data including position-of-interest (POI) operation information; a persistent anchor, which manages both place-based messages and content, which are generated by each subscriber, and content; and a multiuser interaction manager, which manages interpersonal chatting, interaction synchronization between metaverse objects, and the like. Through the API proxy server, a corresponding social service may be provided as a response to a request from the object identification apparatus 11. In this case, location information, geographic information, and the like that are required to provide the social service may be provided from the digital twin server.

The digital twin server may include: a 3D map generation agent for generating a 3D map; and a digital twin agent for aligning information (POI, Ads, location-based service (LBS), V2X, cooperative intelligent transport systems (C-ITS), SNS, and the like), provided by a 3^{rd} party device provider, with map information.

The 3D map generation agent may include: a 3D map source; a multiple map sources handler that processes a plurality of map sources; a map geometry alignment that aligns the map sources according to geometric information; and a map detail enhancement unit that compensates for a phenomenon where pixels for objects are blurred within a map.

The digital twin agent may verify and process whether or not the information provided from the 3^{rd} party device provider is aligned with a metaverse map in a visually proper manner.

Through the API proxy server, the digital twin server may provide 3D map information, which corresponds to vehicular information provided from the object identification apparatus 11, to a rendering-streaming server using a streaming technique.

The rendering-streaming server may be configured to include: a 3D graphic engine; a 3D human machine interface (HMI) framework; a mobility metaverse service (MMS) handler; a map handler; Web real-time communication (webRTC) for communication between web browsers; a real-time interactive webRTC viewer; a quality-of-service (QOS) manager; and the like. In response to a streaming connection request provided from the object identification apparatus 11, a streaming service is provided to the object identification apparatus 11 through the API proxy server. In response to a map request provided from the object identification apparatus 11, the 3D map information provided from the digital twin server may be rendered, and a rendered image may be provided using the streaming technique.

Under the control of the processor 100, the display unit 150 may render an image and display the rendered image. As an example, under the control of the processor 100, the display unit 150 may display an augmented reality image (hereinafter referred to as an augmented reality view) or display a virtual reality image of a 3D virtual space corresponding to the current location of the vehicle 10. A map image may be displayed (hereinafter referred to as a map view) in a bird's-eye view or top view.

The 3D virtual space here may be a metaverse virtual space, and, in this case, the virtual reality image may be an image within the metaverse virtual space. The technique of displaying an image within the metaverse virtual space in this manner is referred to as a metaverse view.

The display unit 150 may also be a display, such as a touch screen, that is provided in the vehicle 10. In this case, the display unit 150 may be connected through the interface unit 170. Furthermore, by controlling the display unit 150 through the interface unit 170, the processor 100 may display an image in accordance with any one of the following: the augmented reality view, the metaverse view, or the map view. However, for convenience in description, an example where the display unit 150 is provided in the object identification apparatus 11 is described below.

Regarding the interface unit 170, the interface unit 170 may be connected to an interface unit (not illustrated) (hereinafter referred to as a vehicular interface unit) of the vehicle 10 and may receive various information, provided by the vehicle 10, through the vehicular interface unit. The vehicular interface unit here may serve as a pathway to various types of external equipment connected to the vehicle 10 or to each component of the vehicle 10. For example, the vehicular interface unit may include various ports connected to the interface unit 170 and be connected to the interface unit 170 through the port. The vehicular interface unit may exchange data with the interface unit 170.

The interface unit 170 may be connected to each component of the vehicle 10 through the vehicular interface unit. As an example, the interface unit 170 may be connected to at least one camera 130 of the vehicle 10 and receive an image captured by the camera 130. The image captured by the camera 130 may be hereinafter referred to as a ‘captured image.’

In addition, the interface unit 170 may be connected to a path guide device 180 of the vehicle 10 through the vehicular interface unit. The interface unit 170 may transfer navigation information, provided from the connected path guide device 180, to the processor 100. Then, the processor 100 may detect the current location, on a path, of the object identification apparatus 11 (or the vehicle 10 equipped with the object identification apparatus 11) based on both the navigation information and the location of the location computation unit 140. Furthermore, the processor 100 may detect the location of a reserved place in accordance with either the location information of the target device, which is provided from the cloud server 20, or a vehicle call service.

Data for supporting various functions of the object identification apparatus 11 may be stored in the memory 160. A multiplicity of application programs (or applications), which are executable by the processor 100, and data and commands for operating the object identification apparatus 11 may be stored in the memory 160.

As an example, information for communication with the target device, for example, the identification information of the target device may be stored in the memory 160. In addition, information about the distance and direction to the target device, the distance and direction being measured with at least one anchor sensor as a reference, may be received by the anchor sensor unit 120, and the received information may be stored in the memory 160. The captured image captured by the camera 130 may be stored in the memory 160. Information about computation algorithms for detecting the distance and direction between each object included within the captured image and the vehicle 10 may also be stored in the memory 160.

In addition, various information, provided from the cloud server 20, may be stored in the memory 160. For example, information about a graphic object for displaying an avatar of another user and an avatar of the vehicle 10 equipped with the object identification apparatus 11 within the metaverse virtual space, location information of both the other user and the vehicle 10, the 3D map information provided from the cloud server 20, and the like may be stored in the memory 160.

The processor 100 controls each connected constituent element and normally controls the overall operation of the object identification apparatus 11. First, through the interface unit 170, the processor 100 may receive information that is computed by the camera 130 of the vehicle 10, the anchor sensor unit 120, and the location computation unit 140. Alternatively, the processor 100 may activate or deactivate at least one anchor sensor included in the anchor sensor unit 120 by controlling the anchor sensor unit 120 through the interface unit 170. In this case, consumption of battery electric power by the vehicle 10 can be minimized by blocking electric power from being supplied to the deactivated anchor sensor.

The processor 100 may calibrate a reference point, based on which the distance and direction to the target device are measured using each anchor sensor, by controlling the anchor sensor unit 120. In this case, the reference point may be a point at which the axis (hereinafter referred to as the central axis), which connects the front surface center and rear surface center of the vehicle 10, intersects with the rear vehicular axis, which connects the centers of the rear wheels of the vehicle 10. The central axis here may be in a direction parallel to the propulsion shaft of the vehicle 10.

The processor 100 may receive an image captured by the camera 130 of the vehicle 10. An object designated from the captured image, for example, a person or vehicle, may be detected. The detected object may be displayed in a manner that is distinguished from other objects.

The processor 100 may detect at least one object corresponding to the location measured using the anchor sensor unit 120, from among the objects measured from the captured image. The detected object may be identified as an object carrying the target device, that is, a target object.

When the target object is identified, the processor 100 may display the identified target object in a manner that is distinguished from other objects. As an example, the processor 100 may receive, from the cloud server 20, information about a graphic object, for example, an avatar that corresponds to the target object. The received avatar may be displayed at a position corresponding to the identified target object in a 3D virtual space view, that is, the metaverse view.

Alternatively, the processor 100 may control the display unit 150 in such a manner that the identified target object is distinguished from other objects. Specifically, the processor 100 may do this in such a manner that a graphic object corresponding to the identified target object is displayed in the captured image or that an augmented reality image, in which a graphic object indicating that the object is a target object is more prominent, is displayed in the vicinity of the identified target object. Alternatively, the processor 100 may control the display unit 150 in such a manner that a map view image, in which a graphic object corresponding to the target object is displayed at the location of the identified target object, is displayed in a map image provided in a bird's-eye view or top view.

The processor 100 may provide information about the location of the identified target object to the cloud server 20. Then, the cloud server 20 may provide a metaverse service corresponding to the location of the identified target object. As an example, the cloud server 20 may provide an object (hereinafter referred to as an avatar), corresponding to the identified target object, in the metaverse virtual space that is provided to another subscriber with whom the identified target object shares the metaverse virtual space, for example, another user (a second user) that is pre-approved by the identified target object (a first user).

Therefore, through an avatar of the first user displayed within a metaverse space, the second user may recognize the presence of the first user in the vicinity of him/herself and request inter-user interaction, such as message exchange or location information sharing. In this case, of course, the avatar of the first user may be displayed in a metaverse view displayed on equipment (for example, a display unit) of the second user and, additionally, an avatar of the second user may also be displayed in a metaverse view displayed on the display unit 150 of the object identification apparatus 11. At the request of the first user, the inter-user interaction, such as message exchange or location information sharing, may also be made.

A case where the object identification apparatus 11 and the vehicle 10 are separated from each other is described with reference to FIG. 1. However, of course, the object identification apparatus 11, as one portion of the vehicle 10, may be integrally formed with the vehicle 10. In this case, the processor 100 of the object identification apparatus 11 may be a control unit of the vehicle 10. In addition, the display unit 150, the communication unit 110, the memory 160, the anchor sensor unit 120, and the location computation unit 140 all may be constituent elements of the vehicle 10.

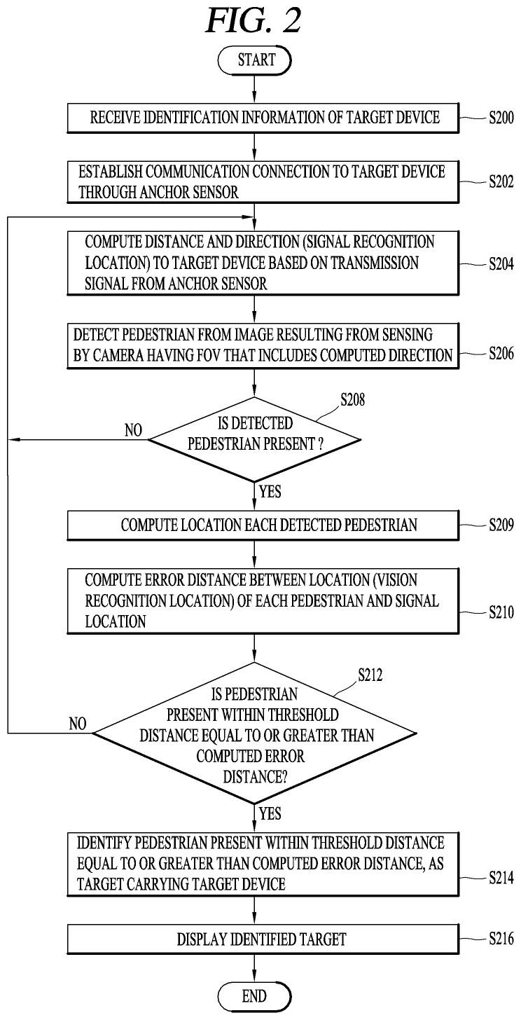

FIG. 2 is a flowchart illustrating the operational process in which the object identification apparatus 11 according to the embodiment of the present disclosure identifies an object in the vicinity of the vehicle 10 based on the result from the capturing by the camera 130 and the result of wireless communication through the anchor sensor.

With reference to FIG. 2, the processor 100 of the object identification apparatus 11 may be described as first receiving the identification information of a target device from the cloud server 20 (S200). The identification information here serves as the identification information of a subscriber who registers with a service that uses the object identification apparatus 11 and may be identification information stored in electronic equipment carried by the subscriber. That is, for example, when a service requester who desires to use a vehicle call service, such as an unmanned taxi service or a vehicle sharing service, requests the vehicle call service through the cloud server 20, the cloud server 20 may transmit the identification information of the service requester to the object identification apparatus 11 provided in the vehicle 10 that supports the provision of the vehicle call service.

In Step S200, the processor 100 that receives the identification information of a target device from the cloud server 20 may attempt to perform wireless communication with the target device having the identification information, by activating the anchor sensor of the anchor sensor unit 120. In this case, the target device serves as equipment in which the identification information is stored and may be equipment capable of performing wireless communication with the anchor sensor of the object identification apparatus 11, in compliance with a preset scheme.

The target device may be one of various types of electronic equipment. As an example, the target device may be any one of the following: a mobile phone, a smartphone, a laptop computer, a personal digital assistant (PDA), a navigation device, a slate PC, a tablet PC, an ultrabook computer, or a wearable device (for example, a smartwatch, smart glasses, or a head-mounted display).

Alternatively, the target device may be equipment to which an RF tag including an RF circuit enabling wireless communication in compliance with the preset scheme is attached. In a case where the target device is equipment incapable of performing wireless communication in compliance with the preset scheme, the equipment, when the RF tag is attached thereto, may serve as a target device according to an embodiment of the present disclosure. In this case, the RF tag may include the identification information and, when a communication connection to the anchor sensor is established, provide the identification information of its own at the request of the anchor sensor.

Therefore, in a case where the vehicle 10 equipped with the object identification apparatus 11 approaches within a distance within which wireless communication with the target device can be performed in compliance with the preset scheme, the target device may perform wireless communication with the anchor sensor in compliance with the preset scheme (S202). Then, the target device may transmit the identification information of the subscriber to the anchor sensor unit 120 at the request of the anchor sensor connected for communication. Based on the received identification information, the anchor sensor unit 120 may identify that the electronic equipment currently connected for communication is a target device (may be paired with the electronic device connected for communication that is a target device).

Then, the anchor sensor unit 120 may exchange a message with the target device paired with the anchor sensor. Time of flight (TOF) may be computed based on the time taken for massage exchange. The direction in which the target device is located may be detected based on the computed TOF, with both the distance between the target device and the anchor sensor and the anchor sensor as references.

A UWB communication scheme may be used as a wireless communication scheme for measuring the distance and direction to the target device in this manner with the anchor sensor as a reference.

For UWB communication, very fast pulses (on the scale of nanoseconds or picoseconds) are used within an ultrabroadband frequency spectrum. UWB communication, which features a very broad bandwidth in a low-frequency band, has the excellent characteristics of passing through an obstacle. Therefore, UWB communication is capable of easily passing through walls and thus has characteristics of reliable coverage inside buildings, in downtown areas, and in forest areas.

In addition, UWB communication consumes significantly less electric power and can display the location of an object (a target device) with a precision that has a maximum error of 30 cm. In addition, UWB communication features a maximum measurement distance of 10 m. In a case where high-power impulse is used, UWB communication has the advantage of increasing the maximum measurement distance by a factor of two.

Time of flight (TOF) and two way ranging (TWR) may be used as techniques of measuring the distance and direction to the target device paired in compliance with the UWB scheme. The TWR technique does not require exact time synchronization with a UWB anchor and can measure distance by exchanging three messages between the anchor and a target device. To this end, the anchor sensor transmits a message to the target device (time recording), and the target device receives the message. Thereafter, the target records the time at which a response message is transmitted and then transmits a response message to the anchor sensor. The arrival time (TOF) of a radio wave propagated for the transmission of the message is computed.

The target device may perform a data discovery phase for pairing with the anchor sensor. After the pairing, the TWR between the anchor sensor and the target device may be conducted. In this case, the target device may periodically transmit a blink message.

The anchor sensor unit 120 may compute the distance between the target device and the anchor sensor using the TOF and the TWR. In a case where a plurality of anchor sensors are provided, the anchor sensor unit 120 may compute the distance between each anchor sensor and the target device under the control of the processor 100.

The anchor sensor unit 120 may detect the direction in which the target device is located, based on an angle of arrival (AOA) of a signal from the target device, the signal being received by the plurality of anchor sensors. That is, the anchor sensor unit 120 may compute the distance between each of the plurality of anchor sensors and the target device based on the time lag between the transmission and reception of the message exchanged with the target device paired with each of the plurality of anchor sensors. Furthermore, the anchor sensor unit 120 may compute the angle at which the target device is located, that is, the direction in which the target device, based on the angle of arrival of the signal received by each of the plurality of anchor sensors from the target device, with the object identification apparatus 11 as a reference. The computed distance and direction to the target device, that is, the location of the target device may be provided to the processor 100 (S204). The location of the target device that, through the anchor sensor unit 120, is detected according to the transmission and reception of a wireless signal between the anchor sensor and the target device is hereinafter referred to as a ‘signal recognition location.’

When the signal recognition location is computed in Step S204, the processor 100 may detect any one camera in accordance with the computed signal recognition location, from among the cameras of the vehicle 10. In this case, from among the cameras, the processor 100 may detect at least one camera whose FOV includes the direction of the target device present at the signal recognition location. A designated object may be detected from an image captured by the detected camera (S206). The designated object here may be a vehicle or a pedestrian.

As an example, the ‘designated object’ in Step S206 may be designated according to a service requested by a subscriber. For example, in a case where the service requested by a subscriber is a service in which a person calls a vehicle, as is the case with the vehicle call service, an object detected in Step S206 may be a pedestrian. In contrast, in a case where another subscriber is detected for display in a metaverse view at the request of the user (a metaverse service), the designated object may include not only a pedestrian but also a vehicle.

With reference to FIG. 2, for convenience, the description assumes that the vehicle call service is requested. Accordingly, for description, it is assumed that an object detected in Step S206 is designated as a pedestrian.

Therefore, in Step S206, the processor 100 may detect a pedestrian from the image captured by the camera having a FOV including the direction in accordance with the signal recognition location.

When a pedestrian begins to be detected in Step S206, the processor 100 may determine whether or not the detected pedestrian is present (S208).

In a case where the result of the determination in Step S208 is that a pedestrian is not detected from the image captured by the camera, the processor 100 may determine that the signal recognition location is erroneously computed. Therefore, Step S204 of computing the signal recognition location of the target device through wireless communication with the target device paired with at least one anchor sensor, and Step S206 of detecting a pedestrian from an image captured by the camera having the FOV in accordance with the signal recognition location may be re-performed.

In contrast, in a case where the result of the determination in Step S208 is that at least one pedestrian is detected, the processor 100 may compute the location of each detected pedestrian from the captured image (S209). The location of an object, which is computed from the image captured by the camera 130 and includes the distance between the camera 130 and the object and the direction of the object, is referred to as a location recognized from the captured image, that is, a ‘vision recognition location.’

The processor 100 may compute an error distance between the computed location (vision recognition location) of each pedestrian and the signal recognition location (S210). It may be determined whether or not a pedestrian is present within a preset threshold distance that is equal to or greater than the error distance computed in Step S210 (S212). In a case where the result of the determination in Step S212 is that a pedestrian is not detected within the preset threshold distance that is equal to or greater than the error distance, the processor 100 may determine that the signal recognition location is erroneously computed. Therefore, Step S204 of computing the signal recognition location of the target device may be repeated, and the process from Step S206 to Step S210 may be repeated.

However, in a case where the result of the determination in Step S212 is that a pedestrian is present within the preset threshold distance that is equal to or greater than the error distance, the processor 100 may identify the pedestrian present within the preset threshold distance that is equal to or greater than the error distance, as a target carrying the target device (S214).

When, among the objects included in the image captured by the camera 130, an object carrying the target device, that is, a target is identified in this manner based on the error distance between the signal recognition location and the vision recognition location, the processor 100 may transmit the location of the identified target to the cloud server 20. The location of the identified target here may be any one of the following: the signal recognition location or the vision recognition location, each of which corresponds to the identified target. The cloud server 20 may provide a metaverse service in which the transmitted location of the target is reflected.

As an example, the cloud server 20 may provide a metaverse space that is shared by the identified target, that is, a subscriber with another user. At this point, the metaverse space shared with the other user may be a space in which the location information of the subscriber and the location information of at least one other user preregistered by the subscriber are displayed. That is, the shared metaverse space may be either a virtual space including a multiplicity of objects that correspond to pedestrians and buildings in the real world, or a virtual space in which the location information of the subscriber and the location information of at least one other user preregistered by the subscriber are shared by each other. In this case, the cloud server 20 may distinguish objects in the virtual space, which correspond to the location information of the subscriber and the location information of the at least one other user, which are collected, from other objects. As an example, the cloud server 20 may distinguish an object corresponding to the location information of the subscriber using an avatar of the subscriber and distinguish an object corresponding to the location information of the other user using an avatar of the other user.

The processor 100 may display the identified target on the display unit 150 in a preset manner (S216).

For example, the processor 100 may display the identified target using the above-described metaverse technology. In this case, the processor 100 may display an image of a three-dimensional virtual space including objects corresponding to real-world objects in the vicinity of the vehicle 10, on the display unit 150 using the metaverse technology. In this case, the image of the three-dimensional virtual space may be an image of the shared metaverse space provided by the cloud server 20. The processor 100 may receive an avatar of the identified target, that is, a subscriber, and an avatar of at least one other user with whom the metaverse space is shared, from the cloud server 20. Avatars that correspond, respectively, to the location of the identified target and the location of at least one other user with whom the metaverse space is shared may be displayed within the received image of the virtual space.

Alternatively, the processor 100 may display the identified target using an augmented reality technology. In this case, using a graphic object, the processor 100 may display a pedestrian, who is present within the threshold distance that is equal to or greater than the error distance, in a manner that is distinguished from other objects within the image. Moreover, of course, the processor 100 may display a location, corresponding to the identified target, in the map image provided in a bird's-eye view or top view.

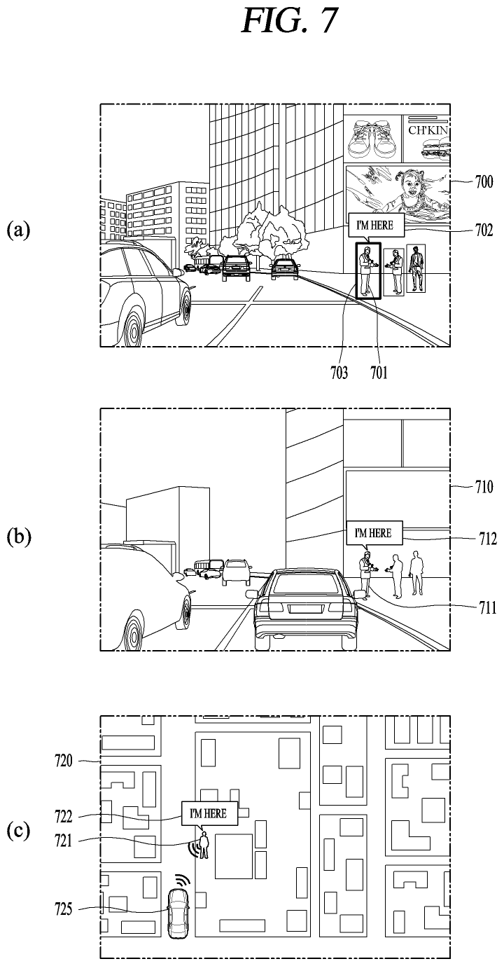

Examples where the identified target is displayed in various techniques on the display unit 150 in a manner that is distinguished from other objects are described in detail below with reference to FIG. 7.

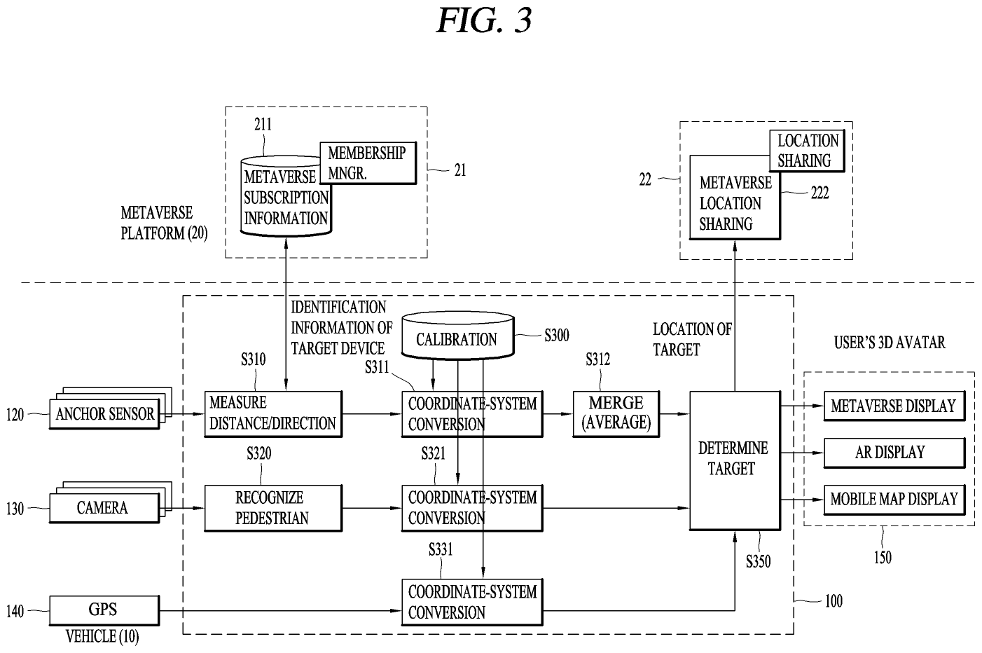

FIG. 3 is a conceptual diagram illustrating the process in which, as described with reference to FIG. 2, the object identification apparatus 11 according to the embodiment of the present disclosure identifies a target and displays the identified target through a link to a metaverse platform that is provided by the cloud server 20.

For convenience in description, a case where the object identification apparatus 11 according to the embodiment of the present disclosure is integrally formed with the vehicle 10 is described below as an example. Accordingly, the vehicle 10 and the object identification apparatus 11 are collectively described as the “vehicle 10,” without distinguishing between them. In this case, the processor 100 of the object identification apparatus 11 may be the control unit of the vehicle 10.

With reference to FIG. 3, the cloud server 20, which provides the metaverse platform, may be described as receiving the identification information of the subscriber in response to a request from the vehicle 10. As an example, the identification information of the subscriber may be provided from an SNS server 21 of the cloud server 20, which stores subscriber information 211 for a metaverse service.

In this case, the identification information of the subscriber may be identification information of a device carried by the subscriber, and, in this case, the device carried by the subscriber may be referred to as a target device. The identification information may be information for identifying the target device, that is, target device identification information.

At least one anchor sensor 120 (the anchor sensor unit 120) provided in the vehicle 10 may attempt to perform wireless communication with equipment corresponding to the target device identification information in compliance with a preset wireless communication scheme, for example, the UWB communication scheme. In this case, if the distance between the vehicle 10 and the target device is greater than the distance where communication is possible in compliance with the UWB communication scheme, communication between the at least one anchor sensor 120 and the target device may not be performed. However, if the distance between the vehicle 10 and the target device is equal to or smaller than the distance where communication is possible in compliance with the UWB communication scheme, the communication between the at least one anchor sensor 120 and the target device may be performed. The at least one anchor sensor 120 and the target device may perform pairing.

The distance between the at least one anchor sensor 120 and the target device may be computed based on the transmission and reception time of a message exchanged through pairing. In addition, the angle of the target device with respect to the at least one anchor sensor 120, that is, the direction of the target device may be computed based on the angle of arrival (AOA) of the signal received by the at least one anchor sensor 120 from the target device (the signal recognition location) (S310).

The processor 100 may detect a pedestrian from an image (an image captured by a camera which has a FOV including the direction of the target device) in the direction corresponding to the direction of the target device (S320). The location (the vision recognition location) of each pedestrian, which is detected from the image, may be detected.

The processor 100 may perform calibration in accordance with a preset reference point on the signal recognition locations, computed from the anchor sensors as a result of computing the signal recognition location and on the locations of the pedestrians, computed as a result of computing the vision recognition location (S300).

The calibration process may be a process for converting a reference point for computing the signal recognition locations and the vision recognition locations into coordinates with the center point of the vehicle 10 as a reference. The reference point may refer to the center point of the vehicle 10. The center point of the vehicle 10 may be a point at which the axis (hereinafter referred to as the central axis or the X-axis), which connects the front surface center and front surface center of the vehicle 10, interacts with the rear vehicular axis (the Y-axis), which connects the centers of the rear wheels of the vehicle 10. The central axis here may be in a direction parallel to the propulsion shaft of the vehicle 10.

Therefore, through the calibration (S300), coordinates of each of the signal recognition locations computed with each anchor sensor as a reference may be coordinate-converted into coordinates in a coordinate system with the center point of the vehicle 10 as a reference (S311). The processor 100 may compute the average coordinate of the signal recognition locations computed with the same reference point, that is, the center point of the vehicle 10, as a reference (S312). The location in accordance with the computed coordinate average may be determined as the signal recognition location.

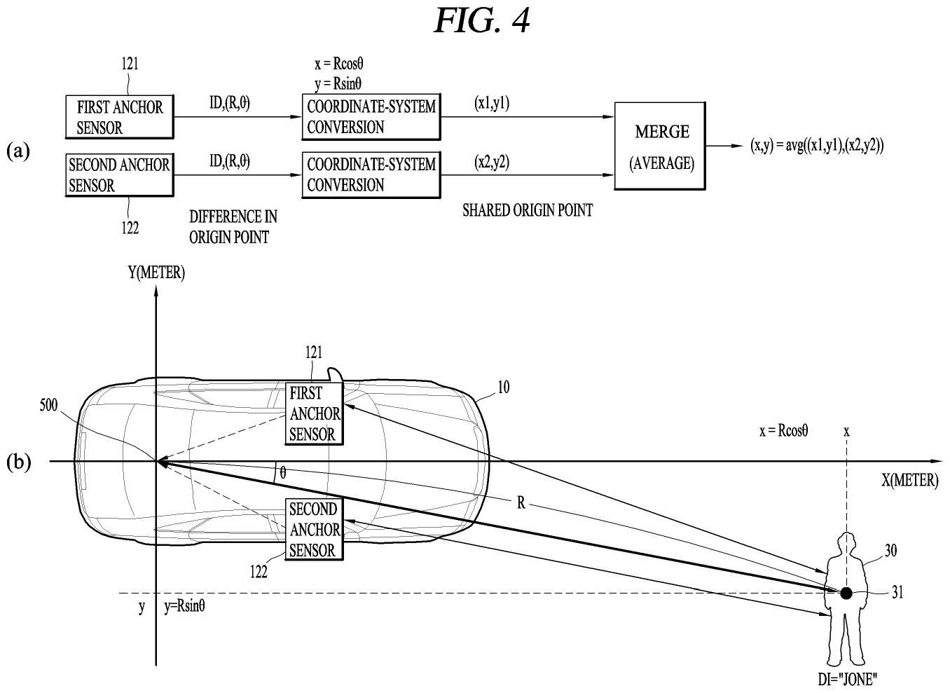

In this manner, coordinates of each of the signal recognition locations computed with each anchor sensor as a reference are coordinate-converted through the calibration (S300) with the center point of the vehicle 10 as a reference. Then, the average (the coordinate average) of the coordinates resulting from the conversion is computed, and thus the signal recognition location is determined. This example of this process is described with reference to FIG. 4.

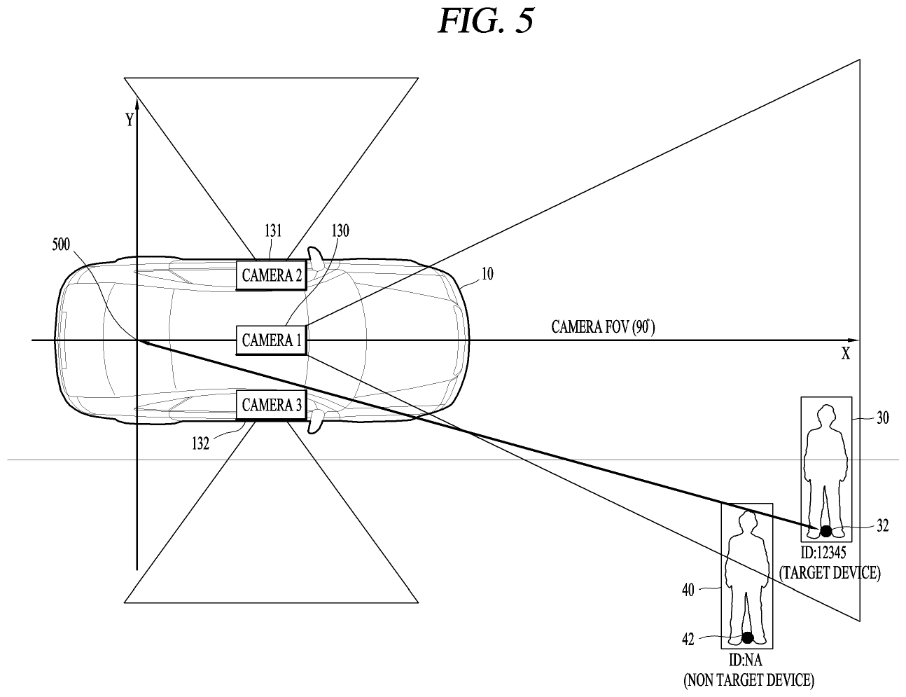

In addition, through the calibration (S300), coordinates of each of the vision recognition locations computed with the location of the camera 130 as a reference may be coordinate-converted into coordinates in the coordinate system with the center point of the vehicle as a reference (S321). Through the calibration (S300), the coordinates of the vision recognition location computed in this manner with the camera 130 as a reference are coordinate-converted with the center point of the vehicle as a reference. An example of this process is described with reference to FIG. 5.

In addition, through the calibration (S300), the current location of the vehicle 10, which is computed by the location computation unit 140, may also be coordinate-converted into coordinates in the coordinate system with the center point of the vehicle 10 as a reference (S331).

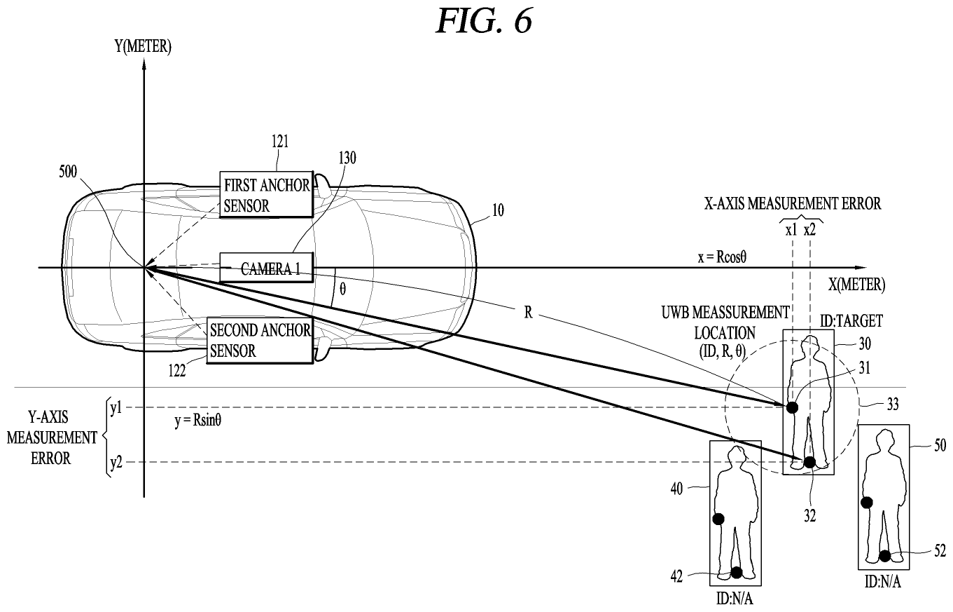

Then, the processor 100 may detect a target based on the signal recognition location computed through the coordinate average (S312), each vision recognition location whose coordinates are converted with the center point of the vehicle 10 as a reference, and the threshold distance (S350). In this case, the processor 100 may compute the error distance between each vision recognition location and the signal recognition location and detect the vision recognition location that is available when the computed error distance is equal to or smaller than the threshold distance. In a case where the vision recognition location is available when the error distance is equal to or shorter than the threshold distance, an object within the image, which corresponds to the vision recognition location, may be determined as a target carrying the target device. A target is identified in this manner based on the computed error distance between each vision recognition location and the signal recognition location. An example of this process is described with reference to FIG. 6.

The processor 100 may provide information about the location of the identified target to the cloud server 20. The location of the identified target here may be any one of the following: the signal recognition location or the vision recognition location, each of which corresponds to the identified target. Then, the cloud server 20 may reflect the location of the identified target, that is, the location of a subscriber in a metaverse space that is shared by the subscriber with another user. Therefore, in the metaverse space provided by the cloud server 20, the avatar of the subscriber may be displayed at a position corresponding to the subscriber. Then, another user with whom the metaverse space is shared may identify whether the subscriber is present in the metaverse space. In a case the subscriber is present, the other user may identify the avatar of the subscriber.

At this point, the server that reflects the location information of the identified subscriber in the metaverse space may be a digital twin server 22. Of course, the SNS server 21 and the digital twin server 22, as illustrated in FIG. 3, may be separate servers but may be a single server.

The avatar of the subscriber reflected in the metaverse space may be displayed on the display unit 150. In this case, within an image of the three-dimensional virtual space, which is displayed using the metaverse technology, the avatar of the subscriber may be displayed at the position of the identified target, that is, the subscriber. Moreover, the subscriber may share the metaverse space with another user, the other user may also be identified, and the location information of the other user may be provided to the cloud server 20. In this case, the processor 100 may display not only the avatar of the subscriber but also the avatar of the other user with whom the metaverse space is shared, within the image of the three-dimensional virtual space, which is displayed using the metaverse technology. Therefore, the subscriber may identify whether or not the other user is present in the metaverse space. In a case where the other user is present, the subscriber may identify the location of the other user.

Alternatively, using a graphic object, the processor 100 may display an object within the image, which corresponds to the identified target, in a manner that is distinguished from other objects (AR display). Alternatively, the location of the identified target may be displayed in a distinguished manner on a map displayed in a bird's-eye view or top view (mobile map display).

FIG. 4 is a conceptual diagram that is referenced to describe the process in which the signal recognition location of an object, which is based on the result of the wireless communication by the anchor sensor, is measured in the vehicle 10 equipped with the object identification apparatus according to the embodiment of the present disclosure.

FIG. 4 illustrates an example where, in a case where the vehicle 10 (that is, the vehicle 10 equipped with the object identification apparatus 11) according to the embodiment of the present disclosure is equipped with two anchor sensors 121 and 122, the signal recognition locations computed with each anchor sensor as a reference are coordinate-converted into coordinates with the center point of the vehicle 10 as a reference, and the coordinate average is computed, thereby computing one signal recognition location.

First, with reference to (b) of FIG. 4, the first anchor sensor 121 and the second anchor sensor 122 are described as anchor sensors that are arranged on the left and right sides, respectively, of the vehicle 10. The signal recognition locations measured using the anchor sensors may be computed with different origin points (the first anchor sensor 121 and the second anchor sensor 122) as references. That is, the angle of arrival of a signal and the distance between the anchor sensor and a target device may be computed with the first and second anchor sensors 121 and 122 as references.

Then, the processor 100 may coordinate-convert the locations and directions in accordance with the signal recognition locations computed with the anchor sensors as references, with the center point 500 of the vehicle 10 as a reference. In this case, when it is assumed that the axis (hereinafter referred to as the central axis), which connects the front surface center and rear surface center of the vehicle 10 is the X-axis and that the rear vehicular axis, which connects the centers of the rear wheels of the vehicle 10 is the Y-axis, the processor 100 may set a point at which the X-axis and the Y-axis intersect with each other, to the center point 500 of the vehicle 10.

Then, the distance and directions in accordance with the signal recognition locations may be computed based on the reference point changed due to the coordinate conversion. Then, based on the distance and direction resulting from the conversion with the center point 500 of the vehicle 10 as a reference, the processor 100 may compute the coordinates of the signal recognition locations measured using the anchor sensors with the center point 500 of the vehicle 10 as a reference.

As an example, the processor 100 may compute first coordinates (X1, Y1) of the target device, corresponding to a distance θ1 and direction R1 to the target device, which are computed using the first anchor sensor 121. In this case, the X-axis coordinate X1 may be computed as R1×cos θ1. The Y-axis coordinate Y1 may be computed as R1×sin θ1.

In addition, the processor 100 may compute second coordinates (X2, Y2) of the target device, corresponding to a distance θ2 and direction R2 to the target device, which are computed using the second anchor sensor 122. In this case, the X-axis coordinate may be computed as R2×cos θ2. The Y-axis coordinate Y2 may be computed as R2×sin θ1.

The processor 100 may compute the average coordinate of the first coordinates (X, Y1) and the second coordinates (X2, Y2). In this case, the X-axis average coordinate may be the average of the X-axis coordinate X1 from the first coordinates and the X-axis coordinate X2 from the second coordinates, and the Y-axis average coordinate may be the average of the Y-axis coordinate Y1 from the first coordinates and the Y-axis coordinate Y2 from the second coordinates. A signal recognition location 31 of a target device 30 may be determined as the computed coordinate average [(X1+X2)/2, (Y1+Y2)/2].

As an example, the configuration in which the signal recognition location is computed using the plurality of anchor sensors is described above. However, of course, the present disclosure may find application in cases where only one sensor is positioned. For example, in a case where one sensor is arranged at the center point 500 of the vehicle 10 or at a position sufficiently close to the center point 500 of the vehicle, the distance measured using this anchor sensor may be a distance to the target device with the center point 500 of the vehicle 10 as a reference. In addition, the angle of arrival of the signal received by the anchor sensor may be an angle, that is, a direction, which corresponds to the location of the target device. In this case, even in a case where one anchor sensor is present, the signal recognition location of the target device may be computed.

FIG. 5 is a conceptual diagram that is referenced to describe the process in which the vision recognition location of an object from the image captured by the camera is measured in the vehicle 10 equipped with the object identification apparatus according to the embodiment of the present disclosure.

With reference to FIG. 5, from among the cameras provided in the vehicle 10, the processor 100 of the vehicle 10 according to the embodiment of the present disclosure may be described as being detected at least one camera corresponding to the FOV that includes the direction of the target device in accordance with the determined signal recognition location. Therefore, as illustrated in FIG. 5, in a case where Cameras 1 to 3 (131 to 133) are provided in the vehicle 10, Camera 1 (131) whose FOV includes the direction of the target device in accordance with the determined signal recognition location, may be selected. Then, the processor 100 may detect a pedestrian from an image captured by Camera 1 (131).

In this case, as illustrated in FIG. 5, if two pedestrians are detected within the captured image in the FOV of Camera 1 (131), the processor 100 may compute the distance between each of the first and second pedestrians 30 and 40 and Camera 1 (131) and the direction in accordance with the location of each of the first and second pedestrians 30 and 40, with the position of Camera 1 (131) as a reference. The computed distance and angle to each pedestrian may be stored as the vision recognition location of each pedestrian.

The processor 100 may coordinate-change the distance and direction of each vision recognition location computed using Camera 1 (131), with the center point 500 of the vehicle 10 as a reference. The distance and direction in accordance with each vision recognition location may be computed on the basis of the reference point that varies according to the coordinate conversion. Then, based on the distances and directions, which result from the conversion with the center point 500 of the vehicle 10 as a reference, the processor 100 may compute vision recognition locations 32 and 42 in accordance with the locations of the pedestrians with the center point 500 of the vehicle 10 as a reference.

As described above, according to the present disclosure, a target may be identified based on the signal recognition locations computed using the anchor sensors and on the vision recognition locations of the detected pedestrians.

FIG. 6 is a conceptual diagram that is referenced to describe the process in which, from among objects within the image, a target is identified based on the signal recognition location measured using the anchor sensor and on the vision recognition location measured using the camera, in the vehicle 10 equipped with the object identification apparatus according to the embodiment of the present disclosure.

With reference to FIG. 6, as described with reference to FIG. 4, the processor 100 may be described as performing coordinate conversion and coordinate averaging on preliminary signal recognition locations computed using the first anchor sensor 121 and the second anchor sensor 122 and thus computing the final signal recognition location 31 with the center point 500 of the vehicle 10 as a reference. As described with reference to FIG. 5, respective vision recognition locations 32, 42, and 52 of pedestrians 30, 40, and 50 detected from the image captured by the camera, which has the FOV including the direction of the target device in accordance with the final signal recognition location, may be computed.

Then, the processor 100 may compute an error distance between the final signal recognition location 31 and each of the vision recognition locations 32, 42, and 52. The error distance here may be computed based on an X-axis error distance and a Y-axis error distance. The X-axis error distance may be a difference between each of the X-axis coordinates of the vision recognition locations 32, 42, and 52 and the X-axis coordinate of the final recognition location 31. The Y-axis error distance may be a difference between each of the Y-axis coordinates of the vision recognition locations 32, 42, and 52) and the Y-axis coordinate of the final recognition location 31.

The processor 100 may detect whether or not the vision recognition location is available when the error distance computed using the X-axis error distance and the Y-axis error distance is equal to or smaller than a preset threshold distance 33. In this case, with reference to FIG. 6, the vision recognition location 32 corresponding to the first pedestrian 30 is described as being within a preset threshold distance from the final signal recognition location 31. Therefore, the processor 100 may identify the first pedestrian 30 as a target, that is, a subscriber who requests a service.

In a case where a target is identified, the processor 100 may display the identified target in various techniques.

FIG. 7 is a set of views illustrating examples where the target object identified in the vicinity of the vehicle 10 is displayed, in a distinguished manner, on an augmented reality, virtual reality, or image map in the object identification apparatus according to the embodiment of the present disclosure.

First, (a) of FIG. 7 illustrates an example where the identified target is displayed using an augmented reality graphic object. In this case, from an image 700 captured by the camera 130, the processor 100 may display at least one augmented reality graphic object 703 or 702 in the vicinity of a specific object 701 corresponding to the identified target, thereby being distinguished from other objects. (b) of FIG. 7 illustrates an example where the identified target is displayed in an image 710 of a virtual space in accordance with the metaverse technology. In this case, the processor 100 may display the identified target as at least one graphic object 711 or 712 preset in such manner as to correspond to the identified target, for example, as an avatar 711, within the image of the virtual space in accordance with the metaverse technology. In contrast, other objects may be displayed in a simplified state, thereby being distinguished from the identified target.

Moreover, the processor 100 may also display the identified target on a map image 720 in a bird's-eye view or top view. In this case, at least one graphic object 721 or 722 representing the identified target may be displayed at one point in the map image, which corresponds to the location of the identified target, and a graphic object 725 representing the current location of the vehicle 10 may be displayed.

As described above, in a case where a target is identified based on the vision recognition location detected from the image captured by the camera 130 and on the signal recognition location detected by performing wireless communication, the processor 100 of the object identification apparatus 11 according to the embodiment of the present disclosure may display the target in the metaverse virtual space through a graphic object, such as an avatar, preset in such a manner as to correspond to the target. However, as described above, in a case where the detected object is identified as a target, the object is not displayed in a manner that is distinguished from other objects.

Accordingly, based on the result of identifying objects in the vicinity of the vehicle, the processor 100 may display the objects in the vicinity of the vehicle 10 differently within the metaverse virtual space.

For example, as described above, in the case of the target identified with both a signal recognition technique that uses the anchor sensor and a vision recognition technique that uses the camera, the processor 100 may display the identified target, using an avatar or the like, in a manner that is distinguished from other objects. In contrast, in a case where an object is detected only with the signal recognition technique, but not with the vision recognition technique, that is, for example, in a case where an object is outside the viewing angle of the camera, the processor 100 may not display the object detected with the signal recognition technique in a manner that is distinguished from other objects. That is, the detected object may be simplified as an object with a simple polygonal shape representing a person for display.

In addition, in a case where an object is detected only with the vision recognition technique, but not with the signal recognition technique, that is, for example, when the target device is deactivated or when an object represents a subscriber who does not carry the target device, the processor 100 may not display the object corresponding to the signal recognition technique in a manner that is distinguished from other objects. That is, the detected object may be simplified as an object with a simple polygonal shape representing a person for display.

Alternatively, an object that is not identified with either the signal recognition technique or the vision recognition technique may be displayed in a fixed shape. That is, in a case where the location of an object is determined by its distance to a vehicle through GPS, the object may be displayed as a graphic object in a fixed shape, such as a circle.

In this case, if the object, detected with either the signal recognition technique or the vision recognition technique, is detected with the other remaining technique, the processor 100 may display the object as an object, such as an avatar, instead of a simplified object with a polygonal shape. That is, objects in the vicinity of the vehicle 10 may be displayed differently within an image of the metaverse virtual space, depending on the detected state of each of the objects in the vicinity of the vehicle 10.

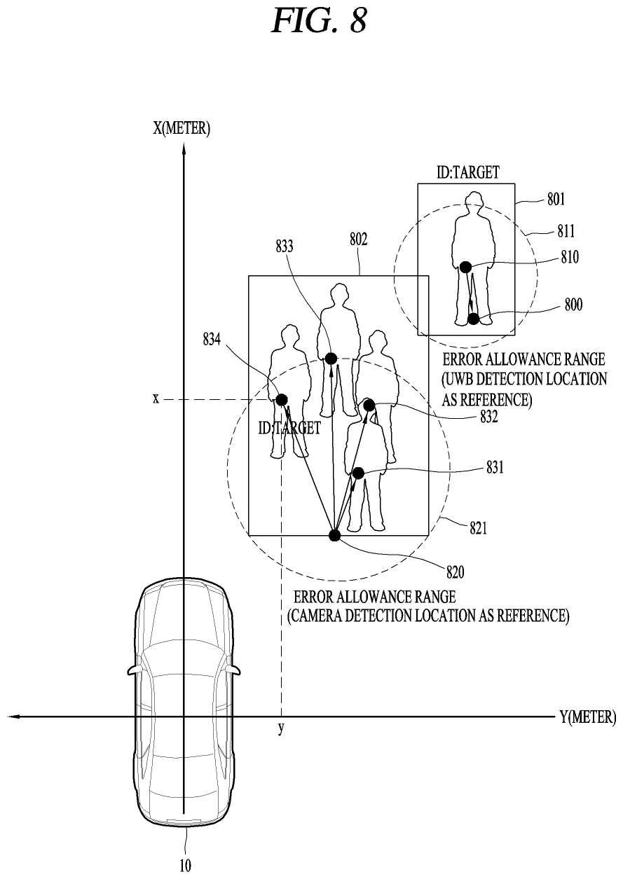

FIG. 8 is a view illustrating an example where an error allowance range is applied in a manner that varies according to the number of objects detected at the vision recognition location, in the object identification apparatus according to the embodiment of the present disclosure.

According to the present disclosure, as illustrated above, the signal recognition location is determined using at least one anchor sensor, and the vision recognition location of each pedestrian within the image captured by the camera is determined. Furthermore, based on the error distance between the determined signal recognition location and vision recognition location, an object corresponding to a specific vision recognition location is detected as a target. That is, like a first object 801 illustrated in FIG. 8, in a case where a vision recognition location 800 is detected within a preset threshold distance 811 from a signal recognition location 810, the first object 801 may be identified as a target.

In a case where, like second objects 802 in FIG. 8, in a case where a plurality of pedestrians are densely present, a plurality of vision recognition locations, that is, vision recognition locations 831, 832, 833, and 834, which correspond to the plurality of pedestrians, respectively, may be included within the preset threshold distance from the signal recognition location.

In this case, the processor 100 may compute the center location 820 of each of the plurality of vision recognition locations, that is, the vision recognition locations 831, 832, 833, and 834. The plurality of pedestrians who are located within a preset threshold distance 821 from the center location 820 may be determined as a target group.

The location of each of the plurality of pedestrians, which are set as the target group may be transmitted to the cloud server 20 to provide the metaverse service. Then, the cloud server 20 may display the plurality of pedestrians around one point in the metaverse virtual space, which corresponds to the computed center location 820, depending on the vision recognitions locations of the plurality of pedestrians. In this case, it is difficult to identify an individual pedestrian corresponding to the target from the plurality of pedestrians displayed as the group. Because of this, the cloud server 20 may provide the image of the metaverse virtual space in which each of the plurality of pedestrians included, as simplified objects in a polygonal shape or the like, in the target group is displayed.

At this point, the cloud server 20 may provide the image of the metaverse virtual space in which the avatar of the subscriber who corresponds to the identified target device, for any one of the plurality of pedestrians included in the target group. In this case, the avatar of the subscriber may be an object whose vision recognition location is closest to the signal recognition location, among objects that correspond, respectively, to the plurality of pedestrians included in the target group.

In addition, in a case where an augmented reality service is provided, the cloud server 20 may provide an image in which an augmented reality object is displayed for each of the plurality of pedestrians included in the target group.

The configuration in which a target is identified based on the signal recognition location computed using at least one anchor sensor and on the vision recognition location computed using the camera is described in detail above.

In a case where the anchor sensor is deactivated to conserve battery power or where it is difficult to establish a communication connection to a target carrying a target device due to an obstacle or the like, the communication connection to the target device hidden behind the obstacle or the like may be established by adjusting the output of the anchor sensor. Embodiments for this process are described below.

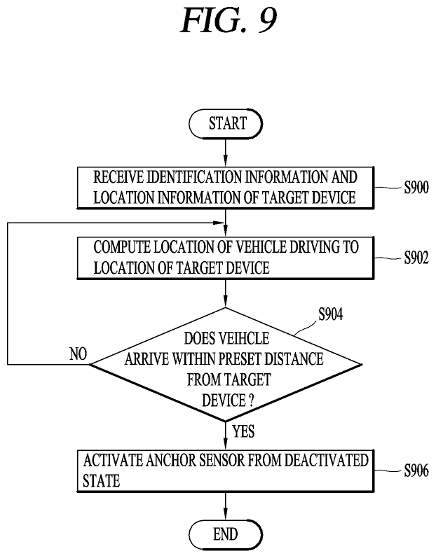

FIG. 9 is a flowchart illustrating the operational process of activating the anchor sensor based on the distance between the vehicle 10 and the target device in the object identification apparatus according to the embodiment of the present disclosure.

With reference to FIG. 9, the processor 100 of the object identification apparatus 11 according to the embodiment of the present disclosure, as illustrated in Step S200 in FIG. 2, may be described as receiving the identification information and the location information of the target device from the cloud server 20 providing the metaverse platform (S900). In this case, under the control of the processor 100, the anchor sensor unit 120 may keep at least one provided anchor sensor in a deactivated state. In this case, the deactivated state of the anchor sensor may be a default operating state of the anchor sensor unit 120.

Then, the processor 100 may compute the location of the vehicle 10 that drives to the location of the target device or to a designated location, using a location computation technique such as GPS (S902). The distance between the computed location of the vehicle 10 and the location of the target device may be computed. It may be determined whether or not the vehicle 10 arrives within a preset distance from the target device (S904).

In Step S904, the preset distance may be a distance corresponding to the maximum communication distance where communication is optimally possible in compliance with a communication scheme that uses the anchor sensor. As an example, in a case where the anchor sensor supports UWB communication, the preset distance may be approximately 200 m.

In a case where the result of the determination in Step S904 indicates that the vehicle 10 has arrived within the preset distance from the target device, the processor 100 may activate the anchor sensor unit 120 from the deactivated state (S906). Then, at least one anchor sensor provided in the anchor sensor unit 120 may be activated and attempt to perform wireless communication with the target device in compliance with a preset wireless communication scheme. In contrast, in a case where the result of the determination in Step S904 indicates that the vehicle 10 has not arrived within the preset distance from the target device, the processor 100 may re-perform Step S902 of computing the location of the vehicle 10 and Step S904 of determining whether or not the vehicle 10 arrives within the preset distance from the target device. Therefore, the anchor sensor unit 120 may be kept in the deactivated state. That is, in a case where the distance between the vehicle 10 and the target device is a distance where communication is impossible using the anchor sensor, the processor 100 may deactivate the anchor sensor, thereby conserving electric power to be consumed for communication.

In a case where the anchor sensor is activated, such as when, as illustrated in FIG. 9, the vehicle 10 arrives within a distance, within which communication is possible using the anchor sensor, from the target device, communication between the anchor sensor and the target device may be established under normal circumstances. However, of course, in a case where an obstacle, such as a wall, is present between the target device and the vehicle 10, communication may not be performed due to the obstruction. In this case, the processor 100 may establish a communication connection to the target device by adjusting the output of the anchor sensor.

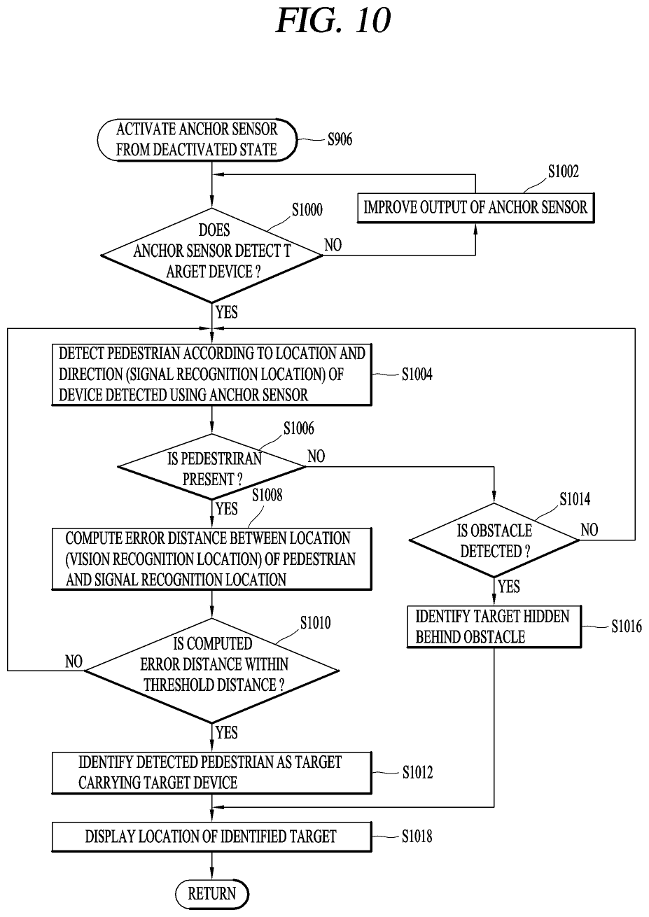

FIG. 10 is a flowchart illustrating the operational process in which, in a case where the target device is not detected, the location of the target object is detected by changing the output of the anchor sensor, in the object identification apparatus according to the embodiment of the present disclosure.

With reference to FIG. 10, as illustrated in FIG. 9, the processor 100 may be described as detecting the target device using the anchor sensor when the vehicle 10 arrives within a distance, within which communication is possible using the anchor sensor, from the target device and thus the anchor sensor is activated (S1000). At this point, the detection of the target device may refer to establishing the communication connection to the target device.

In a case where the result of the detection in Step S1000 indicates that the anchor sensor does not detect the target device, the processor 100 may increase the output of the anchor sensor by a preset magnitude (S1002). The processor 100 may proceed back to Step S1000 and detect the target device using the activated anchor sensor.

Therefore, although the vehicle 10 has arrived within a distance where communication is possible using the anchor sensor, in a case where the communication connection between the anchor sensor and the target device is not established due to an obstacle or the like, the processor 100 may gradually increase the output of the anchor sensor. Therefore, when the output strong enough to pass through the obstacle is generated, the communication connection between the anchor sensor and the target device may be established.

Then, the processor 100 may compute the location and direction, that is, the signal recognition location, using at least one anchor sensor that establishes a communication connection to the target device. A pedestrian located in the direction of the target device may be detected using the camera that captures an image in the FOV including the direction of the target device in accordance with the signal recognition location (S1004).

Based on the result of the detection in Step S1004, it may be determined whether or not a pedestrian is present in the direction in which the target device is located (S1006). In a case where the result of the determination in Step S1006 indicates that a pedestrian is present, the processor 100 may compute the distance and direction to the pedestrian detected from the image captured by the camera, that is, the vision recognition location. The error distance between the computed vision recognition location and the signal recognition location computed in Step S1004 may be computed (S1008).

The processor 100 may compare the computed error distance with a preset threshold distance (S1010). In a case where the computed error distance is within the threshold distance, the detected pedestrian may be identified as a target carrying the target device. The location of the identified target may be displayed on the display unit 150 (S1018). In this case, the location of the identified target may be either the signal recognition location or the vision recognition location of the identified target.

The processor 100 may transmit the location of the identified target to the cloud server 20 providing the metaverse service and display the image of the metaverse virtual space, which is provided from the cloud server 20. In this case, in the image of the metaverse space, an avatar corresponding to the target may be displayed at the position of the identified target.

In a case where the result of the comparison in Step S1010 indicates that the computed error distance is beyond the threshold distance, the processor 100 may determine that the pedestrian detected from the captured image is not a target. Then, the processor 100 may proceed to Step S1004 and repeat the process of detecting a pedestrian based on the direction in accordance with the signal recognition location.

When the result of the determination in Step S1006 indicates that a pedestrian is not detected, in the direction in which the target device is located, from the captured image, the processor 100 may detect whether or not an obstacle, such as a wall, is present between the target device and the vehicle 10 (S1014). When the result of detecting an obstacle in Step S1014 indicates that no obstacle is present, the processor 100 may proceed to Step S1004 and repeat the process of detecting a pedestrian based on the direction in accordance with the signal recognition location.

In contrast, in a case where the result of detecting an obstacle in Step S1014 indicates that an obstacle is detected, the processor 100 may determine that a target is hidden behind the obstacle. That is, the target located behind the obstacle may be identified (S1016). The location of the target hidden behind the obstacle may be displayed on the display unit 150 (S1018).

In this case, the processor 100 may display a graphic object, representing the location of the identified target, in one region of the image in which the obstacle is displayed. For example, in one region of the image in which the obstacle is displayed, an augmented reality object for presenting the location of the identified target may be displayed.

Alternatively, the processor 100 may provide the location information of the identified object, along with the location information of the obstacle, to the cloud server 20. Then, the cloud server 20 may display a graphic object corresponding to the target over the target corresponding to the obstacle within the metaverse virtual space, thereby displaying the location of the target located behind the obstacle. Alternatively, the cloud server 20 may provide the image of the virtual space in which the location of the target is displayed by passing through the object corresponding to the obstacle, to the processor 100. Accordingly, the location of the target hidden behind the obstacle is displayed on the display unit 150.

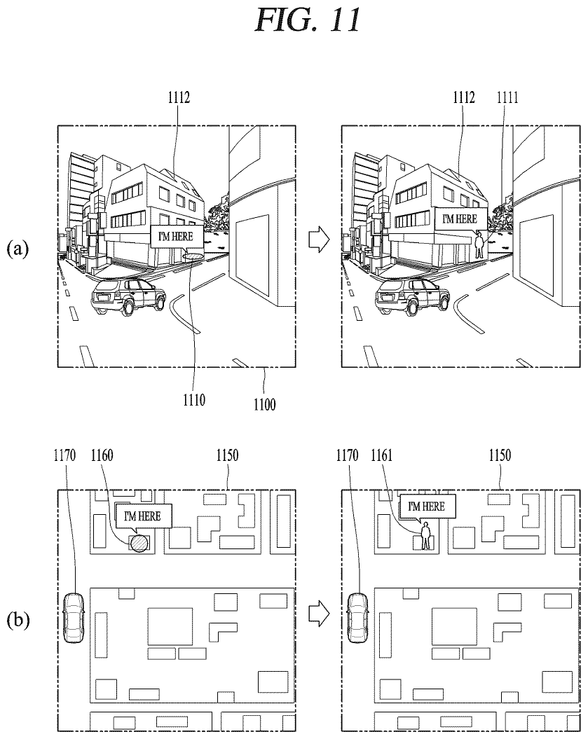

FIG. 11 is a view illustrating examples where, in a case where a target is hidden behind an obstacle or the like, the location of the detected target is displayed in the object identification apparatus according to the embodiment of the present disclosure.

The left portion of (a) of FIG. 11 illustrates a person carrying a target device, that is, the GPS location of a target, behind an obstacle.

In a case where, in this state, according to the embodiment of the present disclosure, which is described with reference to FIG. 10, a target is identified at a location corresponding to the GPS location of the target device, the target is in a state of being hidden behind a building 1112. In this case, the cloud server 20, which provides the metaverse service, may provide the image of the metaverse virtual space, in response to the location information of the identified target and information about the obstacle behind which the target is hidden, that is, information on the building 1112, both of which are provided by the processor 100. In the provided image of metaverse virtual space, one region of the building 1112 behind which the target is hidden is displayed translucently, allowing the shape of the target to be visible, or a graphic object corresponding to the shape of the target is displayed in one region of the building 1112. Then, as illustrated in (a) of FIG. 11, the image of the virtual space in which a graphic object 111 corresponding to the shape of the identified target is displayed in one region (one region behind which the target is hidden, this region being determined by the signal recognition location) of the building 1112 behind which the target is hidden is displayed on the display unit 150.

(b) of FIG. 11 illustrates an example where the signal recognition location of the target whose location detection is impossible using the vision recognition technique due to a corner is displayed, in a top view, in a map image.

As illustrated in the left portion of (b) of FIG. 11, a person who carries a target device may be located across the corner of a road along which the vehicle 10 equipped with the object identification apparatus 11 drives. In this case, a GPS location 1160 of the target device may be displayed in a map image 1150.

In this state, the processor 100 of the object identification apparatus 11 according to the embodiment of the present disclosure may attempt to establish a wireless communication connection using the anchor sensor in compliance with a preset wireless communication scheme. In a case where the wireless communication connection is established using the anchor sensor, the signal recognition location of the target may be identified. In this case, it is assumed that the signal recognition location of the target is identified at a location corresponding to the GPS location 1160.

However, as described above, since the target is located across the corner of the road along which the vehicle 10 drives, vision recognition may be impossible. In this case, the processor 100 may display a graphic object 1161 corresponding to the shape of the identified target at a position in the map image 1150, which corresponds to the signal recognition location of the target. Accordingly, the GPS location of the target may be displayed in a manner that varies according to whether or not the target is identified (the signal recognition location). That is, although the target is difficult to identify in accordance with vision recognition, the processor 100 may display the shape of the target in a manner that varies depending on whether the target is identified in accordance with the signal recognition. Thus, the processor 100 may display not only the more accurate location of the target, but also whether or not the current location of the vehicle 10 approaches up to a location at which identification in accordance with the signal recognition technique is possible.

The example where a service subscriber is identified as a target carrying a specific target device using the object identification apparatus 11 according to the embodiment of the present disclosure is described above. However, of course, if this example is applied, a vehicle in which the service subscriber rides may be identified.

For example, in the case of the vehicle 10 equipped with the object identification apparatus 11 according to the embodiment of the present disclosure, a user of the vehicle 10 may request the identification information of a target device carried by at least one other user from the cloud server 20. In this case, the target device, as described above, may be a mobile terminal or wearable equipment, each of which is carried by the other user, or a vehicle in which the other user rides.

In this case, the processor 100 of the object identification apparatus 11 may perform communication with other vehicles in the vicinity of the vehicle 10 in compliance with a preset wireless communication scheme, for example, the UWB scheme. Thus, the processor 100 may establish a communication connection to the vehicle 10 (hereinafter referred to as a target vehicle) corresponding to a target device received from the cloud server 20. When the communication connection to the target vehicle is established, the direction in accordance with the distance to the target vehicle and the location of the target vehicle may be computed using the transmission time and reception time of a message. That is, the signal recognition location of the target vehicle may be computed.

Then, from among the cameras of the vehicle 10, the processor 100 of the object identification apparatus 11 may detect a camera that captures an image in the direction in accordance with the computed signal recognition location of the target vehicle. Vehicle objects may be detected from among objects included in the image captured by the detected camera, and the distances and directions corresponding to the detected vehicle objects, that is, the vision recognition locations may be computed.

The processor 100 of the object identification apparatus 11 may detect whether or not the vision recognition location, located within a preset error distance from the signal recognition location, is present. In a case where the vision recognition location, located within the preset error distance from the signal recognition location, is detected, the vehicle corresponding to the detected vision recognition location may be identified as a target vehicle.

Then, the processor 100 of the object identification apparatus 11 may provide information about the identified target vehicle to the cloud server 20 providing the metaverse service. Then, based on the information about the target vehicle, the cloud server 20 may provide the image of the metaverse virtual space, including an avatar of another user who corresponds to the identification information of the target vehicle, to the processor 100. Therefore, the processor 100 may display the image of the virtual space in which the avatar of the other user is displayed on the identified target object, on the display unit 150.

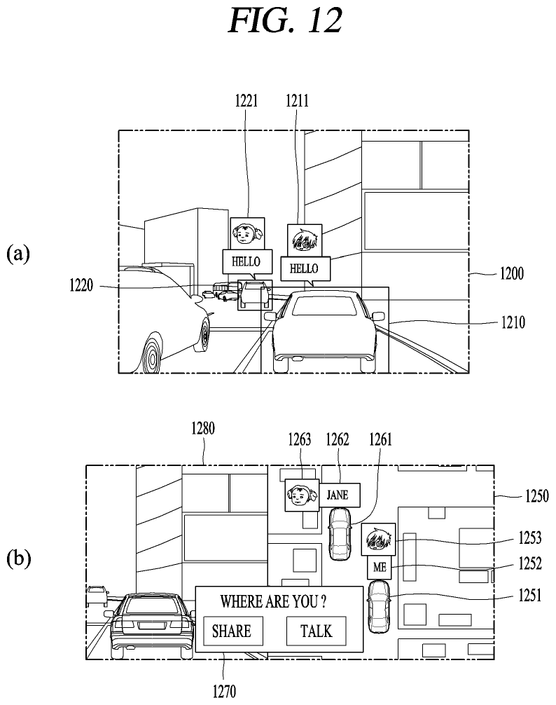

FIG. 12 is a view illustrating examples of the image of the metaverse virtual space that includes the target vehicle on which the avatar of the identified other user is displayed, in the object identification apparatus according to the embodiment of the present disclosure.

(a) of FIG. 12 is a view illustrating the image of the metaverse space in which a vehicle in which another user rides is identified and an avatar corresponding to the other user is displayed on the identified vehicle.

With reference to (a) of FIG. 12, an image 1200 of the metaverse space may be described as including graphic objects that correspond to not only the user's vehicle but also vehicles in the vicinity of the user's vehicle.

In this case, at the request of the user, the cloud server 20 may provide target identification information of at least one other user to the processor 100. Then, the processor 100 may identify the other user's vehicle from among the vehicles in the vicinity of the user's vehicle using the technique described above. Furthermore, the processor 100 may display the other user's avatar 1221 or the like on a graphic object 1220 corresponding to the other user's identified vehicle, thereby distinguishing the graphic object 1220 from other graphic objects.

The image 1200 of the virtual space may be an image of the metaverse space that is shared by the user with a predetermined other user. That is, when the user predesignates at least one other user with whom the user shares a virtual space, the cloud server 20 may provide target identification information of the predesignated at least one other user to the processor 100 of the object identification apparatus 11.

Then, based on the provided target identification information, the processor 100 may detect the other user's vehicle, that is, the target vehicle, in the vicinity of the user's vehicle using the anchor sensor, and identify the target vehicle through the detection result and the vision recognition. When the other user's vehicle is identified, an avatar 1221 representing the identified other user may be displayed on the object 1220 corresponding to the other user's identified vehicle. Therefore, in a case where a vehicle of the predesignated other user's vehicle is present in the vicinity of the user's vehicle, as illustrated in (a) of FIG. 12, an image of the virtual space may be displayed. In this image of the virtual space, the user's avatar 1211 of the user may be displayed on an object 1220 corresponding to the user's vehicle, and the other user's avatar 1221 is displayed on the object 1220 corresponding to the other user's identified vehicle.

In a case where, as described above, the other user's vehicle is identified, the other user's identified vehicle, as illustrated in (b) of FIG. 12, may also be displayed in a map image 1250. That is, graphic objects 1251 and 1261, which correspond, respectively, to the user's vehicle and the other user's identified vehicle, may be displayed in the map image, and graphic objects, for example, tags 1252 and 1262 and avatars 1253 and 1263, which represent the users, may be displayed in the vicinity of the graphic objects, respectively.

The map image 1250 may be displayed in one portion of the region where an image 1280 of the metaverse virtual space is displayed or in one region, resulting from dividing the display unit 150. In addition, in a case where the other user is identified, at the request of the user, the cloud server 20 may also provide a social function, such as location sharing or message exchanging. To this end, the object identification apparatus 11 may transmit the user's request for the social function to the cloud server 20. In response to this request, the cloud server 20 may activate a session of the requested social function. Then, the processor 100 may display a menu screen 1270 on the activated session, which the user or the other user can access. The social function, such as location sharing or message exchanging (talking), may be provided according to the user's or the other user's selection from the menu screen.

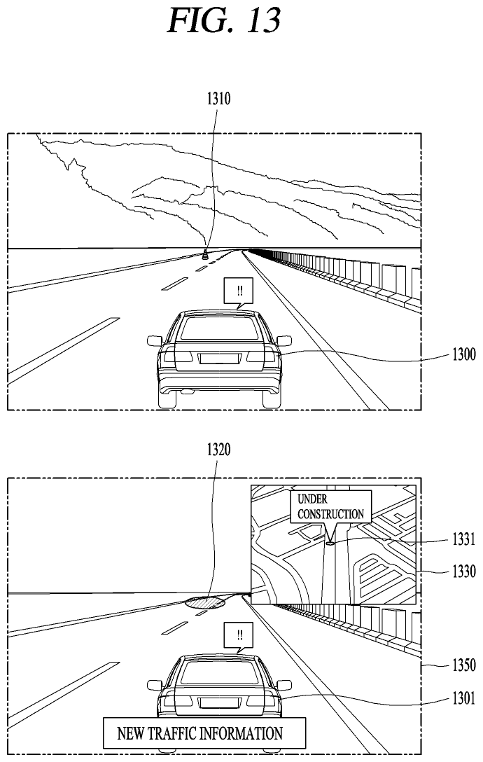

FIG. 13 is a view illustrating an example where traffic information in the vicinity of the vehicle 10 is provided to the metaverse platform and traffic information is displayed within the metaverse virtual space based on the provided traffic information, in the object identification apparatus according to the embodiment of the present disclosure.

As described above, the target device according to the embodiment of the present disclosure may be equipment to which an RF tag, enabling specific wireless communication, is attached. As an example, the RF tag may be a UWB tag including a UWB communication antenna, a UWB communication circuit, and a battery.

As an example, in a case where there occurs a traffic situation, such as emergency road repair work, that requires emergency traffic control, an operator may attach the RF tag to a traffic cone for traffic control. (a) of FIG. 13 illustrates an example where the traffic cone 1310 to which the RF tag is attached for this purpose is located in the vicinity of a vehicle 1300 equipped with the object identification apparatus 11.

In this case, the RF tag may have common target identification information and be formed in such a manner as to transmit a message indicating the traffic control due to the road repair work. In this case, the common identification information may be identification information that is detectable by all the object identification apparatuses 11. That is, in a case where the distance within which the specific wireless communication is possible is available, the anchor sensor of the object identification apparatus 11 may perform wireless communication with an RF tag having the common identification information and receive a preset message from the RF tag.

In addition, the anchor sensor may detect the signal recognition location of the RF tag by exchanging a message with the RF tag. In this case, the signal recognition location may entail coordinate calibration through coordinate conversion.

Objects included in an image captured by a camera, facing the direction that corresponds to the detected signal recognition location, may be detected. Based on depth information of each of the objects included in the captured image, the distance between each of the objects and the camera may be computed. Based on a gap from the center of the image to each of the objects, the direction in accordance with the location of each of the objects included in the image may be computed. The vision recognition location corresponding to each of the objects included in the image may be computed according to the computed distance and direction. In this case, the vision recognition location may entail the coordinate calibration through the coordinate conversion.

When the signal recognition location is detected through wireless signal exchange with the RF tag and at least one vision recognition location is detected from the image captured by the camera, the processor 100 may detect an object corresponding to the RF tag based on the distance between the signal recognition location and each of the vision recognition locations. As an example, the object corresponding to the vision recognition location that is located within a preset error distance from the signal recognition location may be an object corresponding to the RF tag. Accordingly, the processor 100 may detect the location of a target object, that is, the traffic cone, that corresponds to the RF tag. At this point, the location of the target object, that is, the traffic cone may be any one of the following: the signal recognition location of the RF tag or the vision recognition location of the traffic cone, which is detected from the image.

Then, the processor 100 may transmit the detected location of the traffic cone to the cloud server 20 providing the metaverse service. Then, in response to the received location information of the traffic cone, the cloud server 20 may provide the vehicle 10 with the image of the virtual space, as illustrated in (b) of FIG. 13, which includes new traffic information in which the location of the traffic cone is reflected.

With reference to (b) of FIG. 13, a vehicle object 1301 corresponding to the vehicle 1300, and information about the traffic control area 1320 corresponding to the identified location of the traffic cone 1310 may be displayed in a provided image 1350 of the virtual space. In addition, a map image 1330 in which a driving path of the vehicle 10 is displayed may be displayed in a picture-in-picture format, depending on the user's selection. A marking 1331, which includes a message indicating a traffic control situation, may be displayed at a point corresponding to the traffic control area, in the map image 1330.

According to the embodiment of the present disclosure, which is described above, a multiplicity of vehicles parked in a parking lot may, of course, be searched for the user's vehicle, using a method of identifying an object using the signal recognition location and the vision recognition location. In this case, the object identification apparatus 11 according to the embodiment of the present disclosure may be implemented in a mobile terminal owned by a user. In this case, the processor 100 may be a control unit of the mobile terminal. Furthermore, the communication unit 110, the display unit 150, the memory 160, the location computation unit 140, and the camera 130 may correspond to the mobile terminal's communication unit, display unit, memory, location computation unit, and camera, respectively. The anchor sensor unit 120 serves as a module that is provided in the communication unit of the mobile terminal, and may be a module (hereinafter referred to as an anchor module) that supports preset wireless communication (for example, UWB).

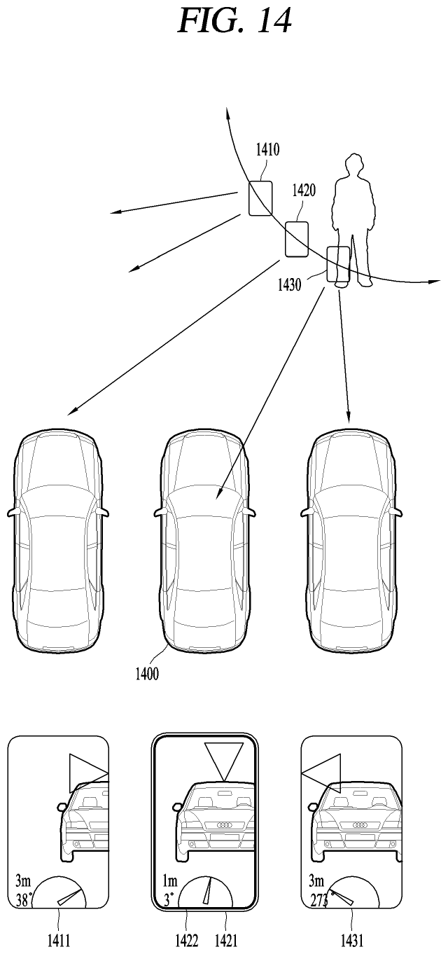

FIG. 14 is a view illustrating an example where a specific vehicle is searched for using a method, according to an embodiment of the present disclosure, of identifying an object.

With reference to FIG. 14, the mobile terminal in which the object identification apparatus 11 is implemented may be described as attempting to perform wireless communication with the user's vehicle 1400 in compliance with preset wireless communication scheme (for example, UWB). As an example, in a case where the distance to the vehicle 1400 is within a distance within which communication in compliance with a preset wireless communication scheme is possible, the anchor module of the mobile terminal may establish a wireless communication connection to the vehicle 1400 and perform pairing with the vehicle 1400.

When pairing is established, the anchor module may compute the distance between the vehicle 1400 and the mobile terminal based on the transmission time and reception time of a message. Based on an angle of arrival at which a signal for the message is received, an angle of the location of the vehicle 1400 with respect to the mobile terminal, that is, the direction in accordance with the location of the vehicle 1400 may be detected. That is, the signal recognition location of the vehicle 1400 may be computed.

When the user moves the location of the mobile terminal to detect his/her vehicle 1400, among the vehicles located in the vicinity of the user, the direction that the camera of the mobile terminal faces may vary according to the movement of the mobile terminal. In this case, the view angles of the camera that vary according to the locations of different mobile terminals are referred to as a first view angle 1410, a second view angle 1420, and a third view angle 1430, respectively. In a case where the view angles vary in this manner, the images captured by the camera may vary. In this case, the image captured at the first angle 1410, the image captured at the second angle 1420, and the image captured at the third angle 1430 are referred to as a first image 1411, a second image 1412, and a third image 1431, respectively.

In this case, the control unit of the mobile terminal may detect whether or not the view angle of the camera includes the direction corresponding to the signal recognition location. A case where the view angle of the camera includes the direction corresponding to the signal recognition location and a case where the view angle thereof does not include the direction thereof may be displayed in a distinguished manner. Therefore, the second image 1421 corresponding to the second view angle 1420 that is a view angle of the camera that corresponds to the signal recognition location may be displayed in a manner that is distinguished from the first image 1411 and the third image 1431 (for example, by displaying an outline 1422).

Moreover, in a case where the view angle of the camera includes a direction that does not align with the direction corresponding to the signal recognition location, guide information for guiding the direction corresponding to the signal recognition location may be displayed in the captured image.

As an example, as illustrated in FIG. 14, guide information indicating the rightward direction and guide information indicating an angle in accordance with a direction corresponding to the signal recognition location from the current view angle center may be displayed in the first image 1411 captured at the first view angle 1410 facing to the left side of the direction corresponding to the signal recognition location. In addition, the distance in accordance with the current computed signal recognition location from the location of the mobile terminal to the vehicle 1400 may be computed.

In addition, guide information indicating the leftward direction and the guide information indicating an angle in accordance with a direction corresponding to the signal recognition location from the current view angle center may be displayed in the third image 1431 captured at the third view angle 1430 facing to the right side of the direction corresponding to the signal recognition location. In addition, the distance in accordance with the current computed signal recognition location from the location of the mobile terminal to the vehicle 1400 may be computed. Accordingly, the user may accurately search for his/her own vehicle 1400 based on the guide information displayed on the display unit of the mobile terminal.

Only in a case where it is possible to compute the signal recognition location and the vision recognition location, communication is performed between the anchor sensor and the target device. Consequently, power consumption by the vehicle 10 equipped with the object identification apparatus 11 and power consumption by the target device may, of course, be reduced.

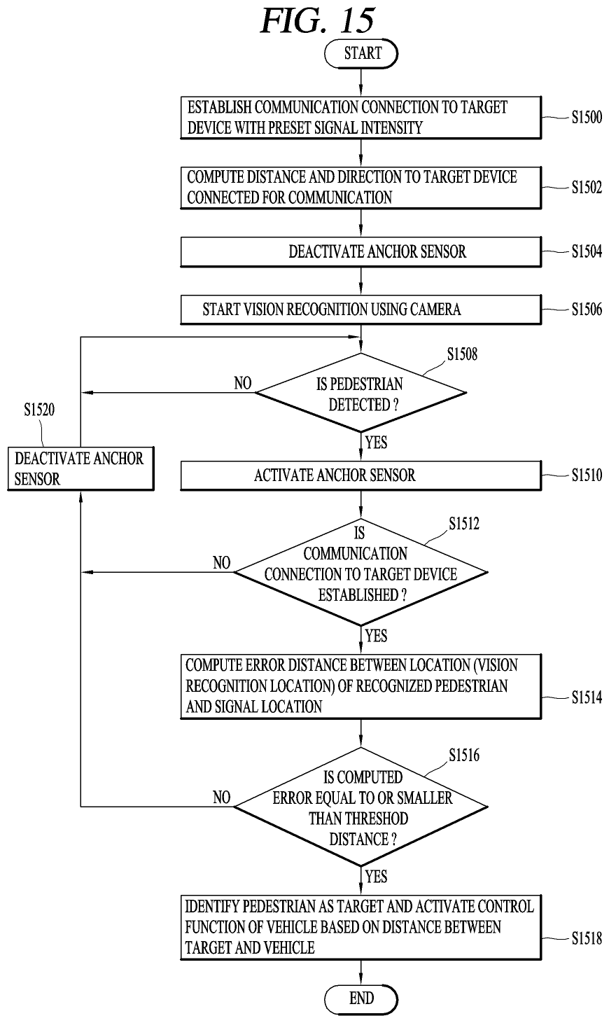

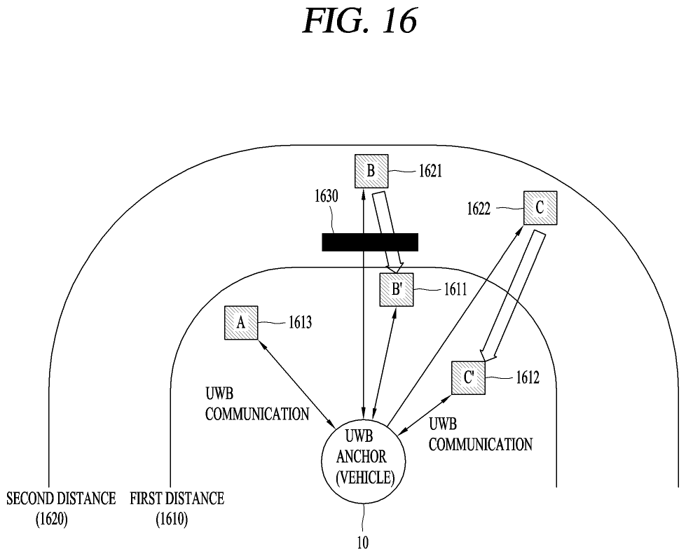

FIG. 15 is a flowchart illustrating the operational process in which the target device and the object identification apparatus limit the wireless communication of the anchor sensor to conserve battery power when distance renders wireless communication unnecessary. FIG. 16 is a view illustrating an example where, according to the flowchart in FIG. 15, communication is performed between the anchor sensor of the vehicle 10 and the target device based on the distance. For convenience in description, an example where the anchor sensor and the target device perform communication in compliance with the UWB communication scheme is described. In this case, the anchor is referred to as an anchor sensor.

First, with reference to FIG. 15, the processor 100 of the object identification apparatus 11 according to the embodiment of the present disclosure may be activated depending on the user's selection. For example, the user may activate a preset application (for example, an application for finding my vehicle) through equipment (for example, a mobile terminal) for remotely controlling a vehicle. Then, according to a control signal from the activated application, the object identification apparatus 11 of the vehicle 10 may be activated.

When the object identification apparatus 11 is activated, the anchor sensor of the object identification apparatus 11, that is, the UWB anchor may also be activated. Then, the processor 100 may control the activated UWB anchor in such a manner that the activated UWB establishes a wireless communication connection to the target device with a preset signal intensity (S1500).

In this case, the preset signal intensity may be stronger than the signal intensity of normal UWB communication. Therefore, in a case where the target device is beyond a normal communication distance (a first distance) 1610 or although the target device is located behind an obstacle 1630, wireless communication with the UWB anchor of the vehicle 10 may also be performed.

The preset signal intensity may be, for example, a signal intensity at maximum output. Then, it may be difficult to perform communication with the target device that is located beyond a maximal distance 1620 (a second distance) within which communication is possible according to the signal intensity at maximum output. However, in a case where communication is performed with the signal intensity at maximum output, even when the target device is located at locations beyond the first distance 1610, that is, at B and C locations 1621 and 1622, communication with the UWB anchor may be performed.

Then, the processor 100 may compute the distance and direction to the target device, that is, the signal recognition location by exchanging a message with the target device to which a communication connection is established (S1504). Then, when the signal recognition location of the target device is computed, the communication with the target device may be terminated by deactivating the UWB anchor (S1506). In this case, when the communication with the target device is terminated by deactivating the UWB anchor, electric power to be consumed by the target device for the UWB communication can be conserved.

Then, in a state where the communication with the target device is terminated by deactivating the UWB anchor, the processor 100 may perform vision recognition through the image captured by the camera facing the direction of the target device in accordance with the signal recognition location (S1506). That is, in a case where, through the camera 130, for example, a pedestrian is detected and confirmed to be actually present, the distance and direction (the vision recognition location) between the camera 130 and the detected pedestrian may be computed. In this case, in a case where a user carrying the target device is located behind the obstacle 1630 such as at the B location 1621, the user may not be detected through the camera. In this case, since the user is not detected, the vision recognition location may not be computed. In contrast, in a case where a user is located at the C location 1622 where an obstacle is not present, the processor 100 may detect the user located at the C location 1622 and compute the vision recognition location.

When a pedestrian is detected and the vision recognition location is computed, the processor 100 may reactivate the UWB anchor (S1510). Then, the activated UWB anchor may attempt to perform communication with the target device (S1512). However, in a case where the target device is located beyond the first distance 1610 within which, normally, UWB communication is performed, such as at the C location 1622, communication between the UWB anchor and the target device may not be performed. Then, the processor 100 may reperform Step S1508 of reactivating the UWB anchor and detecting a pedestrian.

In a case where a user carrying the target device moves from the B location 1621 around the obstacle 1630 to a B′ location 1611 or where a user moves to the A location 1613 or a C′ location 1612, the processor 100 may detect the user through the vision recognition in Step S1508. The detected vision recognition location may be computed through the vision recognition technique. The processor 100 may proceed to Step S1510 and attempt to perform communication with the target device by activating the UWB anchor.

In this case, when the user is located at the A location 1613, the B′ location 1611, or the C′ location 1612, a communication connection between the UWB anchor and the target device may be established since these locations are within the distance within which, normally, UWB communication is possible. Then, the processor 100 may recompute the signal recognition location of the target device through the communication connection between the UWB anchor and the target device and compute the error distance between the recomputed signal recognition location and the vision recognition location of the user (S1514).

In a case where the computed error distance exceeds a preset threshold distance, the processor 100 may determine that the pedestrian detected through the vision recognition is not a person who carries the target device. Then, the processor 100 may proceed to Step S1520 and terminate the communication between the target device and the UWB anchor by deactivating the UWB anchor. The processor 100 may proceed to Step S1508 and repeat the step of detecting a pedestrian through the vision recognition.

In a case where the error distance computed in Step S1514 is equal to or shorter than a preset threshold distance, the processor 100 may identify that the pedestrian detected through the vision recognition is a person who carries the target device. Based on the distance between the identified user and the vehicle 10, the control function of the vehicle 10 may be activated (S1518). Therefore, under the control of the user, a door of the vehicle 10 is opened or the engine of the vehicle 10 may start.

In this manner, in a case where the control function of the vehicle 10 is activated using the method, according to the embodiment of the present disclosure, of identifying an object, the control function of the vehicle 10 may be activated based on the result of identifying the user who carries the target device. Therefore, in a case where a third person who does not carry a target device attempts to control the vehicle 10 using the stolen key device or the like, the third person may be prevented from controlling the vehicle 10.

The present disclosure is possibly implemented as computer-readable codes on a program-recorded medium. The computer-readable media include all types of recording devices in which to store data that are readable by a computer system. Examples of the computer-readable medium include a hard disk drive (HDD), a solid-state disk (SSD), a silicon disk drive (SDD), a ROM, a RAM, a CD-ROM, a magnetic tape, a floppy disk, an optical data storage device, and the like. The computer-readable medium may also be implemented in the form of a carrier wave (such as for transmission over the Internet). In addition, the computer may include the processor 100 of the object identification apparatus 11. Therefore, the detailed description should not be interpreted in a limiting manner in all respects, and should be considered as serving illustrative purposes. The scope of the present disclosure should be determined by proper construction of the following claims. All equivalent modifications to the embodiments of the present disclosure fall within the scope of the present disclosure.

1. An object identification apparatus comprising:
an interface unit that receives an image of a vehicle's surroundings, acquired by at least one camera provided in the vehicle;
at least one anchor sensor that attempts to wireless communication with a target device, corresponding to pre-stored identification information, in compliance with a preset communication scheme, and, when a wireless communication connection to the target device is established, exchanges at least one message for computing the location of the target device; and
a processor that computes the location of the target device based on a state of the wireless communication connection of the at least one anchor sensor to the target device, receives an image, captured by the camera facing the direction of the target device, through the interface unit, computes the locations of objects included in the received image, and identifies any one object located within a preset error distance from the computed location of the target device, among the locations of the objects, which are computed through the image, as a target corresponding to the target device.

2. The object identification apparatus of claim 1, further comprising:
a communication unit that performs wireless communication with a cloud server which provides a metaverse platform and provides a service associated with a metaverse virtual space to the vehicle through the metaverse platform,
wherein the processor transmits the location information of any one target identified as corresponding to the target device, among objects in the vicinity of the vehicle, to the cloud server, and, in response to the transmission of the location information of the identified target, receives information about the metaverse virtual space in which an avatar corresponding to the identified target is displayed in the vicinity of the vehicle, from the cloud server.

3. The object identification apparatus of claim 2, wherein the location information of the identified target is any one of the following: a first location corresponding to the direction of the target device, which is computed both from the distance to the target device, the distance being computed using the transmission time and reception time of a message exchanged between the at least one anchor sensor and the target device and from an arrival of angle (AOA) of a signal received from the target device, or a second location corresponding to a direction which is computed both from a distance that is computed using the depth information of an object corresponding to the identified target included in the image captured by the camera facing the direction of the target device and from a gap from the view angle center of the captured image to the center of the object corresponding to the identified target.

4. The object identification apparatus of claim 2, wherein the cloud server, when receiving the location information of the identified target, further detects another user with whom the metaverse virtual space is preset to be shared in the vicinity of the location of the vehicle, and, as a result of the detection, further transmits an avatar of and the location information of at least one other user with whom the metaverse virtual space is shared, to the processor, and
wherein the processor controls the interface unit in such a manner that an image of the metaverse virtual space in which an avatar of the identified target and the avatar of the at least one other user are displayed in the vicinity of an object corresponding to the vehicle, is displayed on a display unit of the vehicle.

5. The object identification apparatus of claim 2, wherein the processor controls the interface unit in such a manner that the received image of the metaverse virtual space is displayed on a display unit of the vehicle, and
wherein the image of the metaverse virtual space is an image in which the object identified as corresponding to the target device, among the objects in the vicinity of the vehicle, is displayed as the avatar in a manner that is distinguished from the other remaining objects that are not identified.

6. The object identification apparatus of claim 2, wherein, in a case where a location in the image, which corresponds to the target device, is a wall or an obstacle, as a result of detecting the location of the target device in accordance with the state of the wireless communication connection to the target device, from the image captured by the camera facing the direction of the target device, the processor detects that the target corresponding to the target device is hidden behind the wall or the obstacle, and controls the interface unit in such a manner that an image of the metaverse virtual space, in which the wall or the obstacle in the image, each of which corresponds to the location of the target device, or the avatar is displayed translucently and thus the location of the target corresponding to the target device hidden behind the wall or the obstacle is displayed, is displayed on a display unit of the vehicle.

7. The object identification apparatus of claim 2, wherein the identification information of the target device is information about target equipment carried by a subscriber of a specific service provided by the cloud server.

8. The object identification apparatus of claim 7, wherein the target equipment is communication equipment supporting wireless communication in compliance with the preset communication scheme or equipment to which a tag including a radio frequency (RF) circuit capable of performing the wireless communication in compliance with the preset communication scheme is attached.

9. The object identification apparatus of claim 1, wherein the preset communication scheme is a communication scheme that uses a wireless signal in an ultrawide band (UWB).

10. The object identification apparatus of claim 1, wherein the processor sets one point in the vehicle as a reference point, and calibrates the location of the target device, which is computed with the at least one anchor sensor with a reference, as a location with the reference point as a reference, through coordinate conversion from a coordinate system with the location of each anchor sensor as a reference to a coordinate system with the set reference point as a reference.

11. The object identification apparatus of claim 10, wherein the number of the anchor sensors is 2 or greater, and
wherein, through the coordinate conversion, the processor calibrates the locations of the target device, which are computed with each of the two or more anchor sensors as a reference, as locations in accordance with the coordinate systems with the reference point as a reference, and computes the coordinate average of the locations resulting from the calibration, thereby determining the location of the target device.

12. The object identification apparatus of claim 1, wherein the processor sets one point in the vehicle as a reference point, and calibrates the location of the target device, which is computed with the location of the camera as a reference, to a location with the reference point as a reference, through coordinate conversion from a coordinate system with the location of each anchor sensor as a reference to a coordinate system with the set reference point as a reference.

13. The object identification apparatus of claim 10, wherein the reference point is a point at which the center axis, connecting the front surface center of the vehicle and the rear surface center of the vehicle, intersects with the rear vehicular axis, connecting the centers of the rear wheels of the vehicle.

14. The object identification apparatus of claim 1, wherein the processor detects any one camera that captures an image corresponding to a field of view (FOV) including the direction of the target device, the direction being computed based on the state of the wireless communication connection to the target device, from among the plurality of cameras provided in the vehicle, and computes the locations of the objects included in the image captured by the detected camera.

15. The object identification apparatus of claim 1, further comprising:
a location computation unit that computes the GPS location of the vehicle and the GPS location of the target device,
wherein, in a case where as a result of computing the locations, the distance between the GPS location of the vehicle and the GPS location of the target device exceeds a preset distance, the processor keeps the at least one anchor sensor in a deactivated state, and
wherein, in a case where the distance between the GPS location of the vehicle and the GPS location of the target device is equal to or shorter than the preset distance, the processor switches the at least one anchor sensor from the deactivated state to an activated state, thereby establishing the wireless communication connection between the at least one anchor sensor and the target device.

16. The object identification apparatus of claim 2, wherein in a case where a plurality of objects are located within the preset error distance from the computed target device, the processor identifies at least one of the plurality of objects as a target group corresponding to the target device, based on the locations of the objects, the locations being computed from the image, and transmits the location information of each of the objects included in the target group to the cloud server.

17. The object identification apparatus of claim 16, wherein in response to the location information of each of the objects included in the target group, the cloud server displays an avatar, corresponding to the identified target, on any one object whose location computed from the captured image is most adjacent to the location of the target device in accordance with the state of the wireless communication connection to the target device, among the objects included in the target group, and, in response to the transmission of the location information of the objects included in the target group, provides an image of the metaverse virtual space in which the other remaining objects in the target group are displayed.

18. A method of controlling an object identification apparatus, the method comprising:
a step of receiving the identification information of a specific target device;
a step of attempting to perform wireless communication with the target device in compliance with preset communication scheme using at least one anchor sensor and performing pairing with the target device when a wireless communication connection to the target device is established;
a step of exchanging, by the at least one anchor sensor, a message for computing the location of the target device and computing the location of the target device by exchanging the message, when the pairing is established;
a step of detecting a camera that captures an image in a direction in accordance with the location of the target device, from a vehicle;
a step of computing the locations of objects within the image captured by the detected camera, the locations including the distances and directions of the objects from the camera, based on depth information and the view angle center;
a step of detecting the location of an object located within a preset error distance from the target device, from among the computed locations of the objects; and,
a step of identifying an object in the image, the object being located within the error distance from the target device, as a target corresponding to the target device.

19. The method of claim 18, the method further comprising:
a step of transmitting the location information of an identified target corresponding to the target device to a cloud server that provides a metaverse platform and provides a service associated with a metaverse virtual space through the metaverse platform;
a step of receiving information about the metaverse virtual space including an avatar corresponding to the identified target, in response to the transmission of the location information; and
a step of displaying, according to the received information about the metaverse virtual space, an image of the metaverse virtual space in which the avatar is displayed at the location of the identified target, on a display unit of the vehicle.
